(19) United States
(12) Patent Application Publication
(10) Pub. No.: US 2024/0121655 A1
(43) Pub. Date: Apr. 11, 2024

(54) END-TO-END QUALITY OF SERVICE VIA A CUSTOMER PREMISES EQUIPMENT

(71) Applicant: QUALCOMM Incorporated, San Diego, CA (US)

(72) Inventors: Xiaolong Huang, Santee, CA (US); Patrick Poon-Cheuk Chan, San Jose, CA (US); Sebastian Speicher, Wallisellen (CH); Huichun Liu, San Diego, CA (US); Suli Zhao, San Diego, CA (US); Sai Yiu Duncan Ho, San Diego, CA (US); John Thomas Harrsen, San Jose, CA (US)

(21) Appl. No.: 17/960,454

(22) Filed: Oct. 5, 2022

(51) Int. Cl. H04W 28/02

(52) U.S. Cl. CPC H04W 28/0268; H04W 28/0263

(57) ABSTRACT

Methods, systems, and devices for wireless communication are described. For example, the described techniques provide for a first device (e.g., a cellular modem or user equipment (UE)) mapping quality of service flows of a first radio access technology (e.g., cellular) to service classes of a second RAT (e.g., Wi-Fi). The first device may communicate mapping information that indicates the mapping to a second network device (e.g., a router). The first device and the second device may communicate various packets via the quality of service flows and the service classes.

### FIELD OF TECHNOLOGY

The following relates to wireless communication, including end-to-end quality of service via a customer premises equipment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support local networks, such as a Wi-Fi networks. For example, a cellular device, such as a UE may communicate with a network entity using a first radio access technology (RAT), and support communications with other devices via a second RAT, such as Wi-Fi. In some examples, communications via the first RAT and/or the second RAT may be associated with a quality of service (QoS) requirements.

### SUMMARY

The described techniques relate to improved methods, systems, devices, and apparatuses that support end-to-end quality of service (QoS) via a customer premises equipment (CPE). For example, the described techniques provide for a first device (e.g., a cellular modem or user equipment (UE)) mapping QoS flows of a first radio access technology (e.g., cellular) to service classes of a second radio access technology (e.g., Wi-Fi). The first device may communicate mapping information that indicates the mapping to a second network device (e.g., a router). The first device and the second device may communicate various packets via the QoS flows and the service classes.

A method for wireless communication at a first network device is described. The method may include transmitting, to a second network device, mapping information indicating a mapping of each QoS flow of a set of multiple QoS flows of a first RAT to one or more service classes of a set of multiple service classes of a second RAT, where the mapping is based on a set of QoS parameter values for the set of multiple QoS flows and communicating, based on the mapping information, a packet between a first QoS flow of the set of multiple QoS flows and a first service class of the set of multiple service classes.

An apparatus for wireless communication at a first network device is described. The apparatus may include a processor, memory coupled with the processor, and instructions stored in the memory. The instructions may be executable by the processor to cause the apparatus to transmit, to a second network device, mapping information indicating a mapping of each QoS flow of a set of multiple QoS flows of a first RAT to one or more service classes of a set of multiple service classes of a second RAT, where the mapping is based on a set of QoS parameter values for the set of multiple QoS flows and communicate, based on the mapping information, a packet between a first QoS flow of the set of multiple QoS flows and a first service class of the set of multiple service classes.

Another apparatus for wireless communication at a first network device is described. The apparatus may include means for transmitting, to a second network device, mapping information indicating a mapping of each QoS flow of a set of multiple QoS flows of a first RAT to one or more service classes of a set of multiple service classes of a second RAT, where the mapping is based on a set of QoS parameter values for the set of multiple QoS flows and means for communicating, based on the mapping information, a packet between a first QoS flow of the set of multiple QoS flows and a first service class of the set of multiple service classes.

A non-transitory computer-readable medium storing code for wireless communication at a first network device is described. The code may include instructions executable by a processor to transmit, to a second network device, mapping information indicating a mapping of each QoS flow of a set of multiple QoS flows of a first RAT to one or more service classes of a set of multiple service classes of a second RAT, where the mapping is based on a set of QoS parameter values for the set of multiple QoS flows and communicate, based on the mapping information, a packet between a first QoS flow of the set of multiple QoS flows and a first service class of the set of multiple service classes.

Some examples of the method, apparatuses, and non-transitory computer-readable medium described herein may further include operations, features, means, or instructions for receiving, from the second network device, an indication of the set of multiple service classes of the second RAT and where each QoS flow may be mapped to the one or more service classes based on receiving the indication of the set of multiple service classes.

Some examples of the method, apparatuses, and non-transitory computer-readable medium described herein may further include operations, features, means, or instructions for receiving, via the first RAT, control signaling indicating the set of QoS parameter values per QoS flow of the set of multiple QoS flows.

In some examples of the method, apparatuses, and non-transitory computer-readable medium described herein, the control signaling includes a set of internet protocol addresses that are to be communicated via a QoS flow of the set of multiple QoS flows and the QoS flow may be mapped to at least one of the set of multiple service classes based on the set of internet protocol addresses.

In some examples of the method, apparatuses, and non-transitory computer-readable medium described herein, the set of internet protocol addresses may be received from a policy control function associated with the first RAT.

In some examples of the method, apparatuses, and non-transitory computer-readable medium described herein, the mapping information includes an indication of the set of internet protocol addresses that are to be communicated via the QoS flow.

Some examples of the method, apparatuses, and non-transitory computer-readable medium described herein may further include operations, features, means, or instructions for receiving, from the second network device, an indication of the set of multiple service classes of the second RAT, transmitting, based on receiving the indication of the set of multiple service classes and using a default QoS flow, uplink control signaling requesting the set of multiple QoS flows, and receiving, via the first RAT based on transmitting the uplink control signaling, control signaling indicating the set of QoS parameter values per QoS flow of the set of multiple QoS flows.

In some examples of the method, apparatuses, and non-transitory computer-readable medium described herein, the uplink control signaling may be transmitted to a policy control function associated with the first RAT.

In some examples of the method, apparatuses, and non-transitory computer-readable medium described herein, communicating the packet may include operations, features, means, or instructions for receiving, from the second network device, the packet including a traffic identifier and transmitting the packet via the first QoS flow based on the traffic identifier that may be mapped to the first QoS flow.

Some examples of the method, apparatuses, and non-transitory computer-readable medium described herein may further include operations, features, means, or instructions for removing the traffic identifier from the packet before transmitting the packet via the first QoS flow based on the traffic identifier corresponding to an internet protocol based QoS flow.

In some examples of the method, apparatuses, and non-transitory computer-readable medium described herein, the packet including the traffic identifier may be transmitted via the first QoS flow based on the first QoS flow being an Ethernet based QoS flow.

In some examples of the method, apparatuses, and non-transitory computer-readable medium described herein, the traffic identifier may be a VLAN tag.

In some examples of the method, apparatuses, and non-transitory computer-readable medium described herein, the mapping information may be transmitted via a DHCP message, a serial communication, or a hypertext transfer protocol (HTTP) message.

In some examples of the method, apparatuses, and non-transitory computer-readable medium described herein, the mapping information may be transmitted by a DHCP (DHCP) server at the first network device and via a DHCP offer message that may be transmitted to a DHCP client at the second network device and the DHCP offer message includes the mapping information and indicates an identifier configured to cause the DHCP client to refrain from discarding the DHCP offer message.

Some examples of the method, apparatuses, and non-transitory computer-readable medium described herein may further include operations, features, means, or instructions for refraining from mapping an ethernet port of the second network device to a QoS flow.

In some examples of the method, apparatuses, and non-transitory computer-readable medium described herein, the second network device and the first network device may be included in a customer premises equipment (CPE).

In some examples of the method, apparatuses, and non-transitory computer-readable medium described herein, the set of QoS parameter values per QoS flow include a delay budget value, a packet error rate value, a priority value, a bit rate value, a data burst volume value, a reflective QoS attribute value, periodicity value, or a combination thereof and each service class of the set of multiple service classes may be associated with a delay bound value, a packet loss ratio value, a priority value, a minimum throughput value, a maximum throughput value, a burst size value, a priority value, a service interval value, or a combination thereof.

Some examples of the method, apparatuses, and non-transitory computer-readable medium described herein may further include operations, features, means, or instructions for mapping each QoS flow of the set of multiple QoS flows to one or more service classes of the set of multiple service classes based on a QoS identifier of the set of multiple QoS flows and a mapping table including the set of multiple service classes, description information associated with each QoS flow, and packet filter information.

In some examples of the method, apparatuses, and non-transitory computer-readable medium described herein, transmitting the mapping information may include operations, features, means, or instructions for transmitting an indication of one or more QoS identifiers that may be mapped to a service class of the set of multiple service classes, description information associated with each QoS flow, a packet filter set per QoS flow, or any combination thereof.

In some examples of the method, apparatuses, and non-transitory computer-readable medium described herein, transmitting the mapping information may include operations, features, means, or instructions for transmitting description information that indicates a maximum flow bit rate per QoS flow, a guaranteed flow bit rate per QoS flow, an averaging window per QoS flow, the QoS identifier per QoS flow, or a combination thereof.

In some examples of the method, apparatuses, and non-transitory computer-readable medium described herein, the first RAT may be cellular communications technology and the second RAT may be Wi-Fi.

A method for wireless communication at first network device is described. The method may include receiving, from a second network device, mapping information indicating a mapping of each QoS flow of a set of multiple QoS flows of a first RAT to one or more service classes of a set of multiple service classes of a second RAT supported by the first network device, translating, using a translation rule included in the mapping information, a header of a packet between a first network address of the first RAT and a second network address used by the first network device, and communicating the packet between a device associated with the first network device using a first service class of the set of multiple service classes and a first QoS flow of the set of multiple QoS flows based on translation of the header.

An apparatus for wireless communication at first network device is described. The apparatus may include a processor, memory coupled with the processor, and instructions stored in the memory. The instructions may be executable by the processor to cause the apparatus to receive, from a second network device, mapping information indicating a mapping of each QoS flow of a set of multiple QoS flows of a first RAT to one or more service classes of a set of multiple service classes of a second RAT supported by the first network device, translate, using a translation rule included in the mapping information, a header of a packet between a first network address of the first RAT and a second network address used by the first network device, and communicate the packet between a device associated with the first network device using a first service class of the set of multiple service classes and a first QoS flow of the set of multiple QoS flows based on translation of the header.

Another apparatus for wireless communication at first network device is described. The apparatus may include means for receiving, from a second network device, mapping information indicating a mapping of each QoS flow of a set of multiple QoS flows of a first RAT to one or more service classes of a set of multiple service classes of a second RAT supported by the first network device, means for translating, using a translation rule included in the mapping information, a header of a packet between a first network address of the first RAT and a second network address used by the first network device, and means for communicating the packet between a device associated with the first network device using a first service class of the set of multiple service classes and a first QoS flow of the set of multiple QoS flows based on translation of the header.

A non-transitory computer-readable medium storing code for wireless communication at first network device is described. The code may include instructions executable by a processor to receive, from a second network device, mapping information indicating a mapping of each QoS flow of a set of multiple QoS flows of a first RAT to one or more service classes of a set of multiple service classes of a second RAT supported by the first network device, translate, using a translation rule included in the mapping information, a header of a packet between a first network address of the first RAT and a second network address used by the first network device, and communicate the packet between a device associated with the first network device using a first service class of the set of multiple service classes and a first QoS flow of the set of multiple QoS flows based on translation of the header.

In some examples of the method, apparatuses, and non-transitory computer-readable medium described herein, the mapping information includes an indication of a set of internet protocol addresses that are to be communicated to a QoS flow and the header may be translated based on the set of internet protocol addresses.

Some examples of the method, apparatuses, and non-transitory computer-readable medium described herein may further include operations, features, means, or instructions for transmitting, to the second network device, an indication of the set of multiple service classes and where the mapping information may be received based on transmitting the indication of the set of multiple service classes.

Some examples of the method, apparatuses, and non-transitory computer-readable medium described herein may further include operations, features, means, or instructions for transmitting, to the second network device, a second packet that includes a traffic identifier that may be mapped to a default QoS flow associated with the first RAT and where the mapping information may be received based on transmitting the second packet.

Some examples of the method, apparatuses, and non-transitory computer-readable medium described herein may further include operations, features, means, or instructions for receiving from the device the second packet via a default service class and where the second packet may be transmitted to the second network device based on receiving the second packet from the device.

In some examples of the method, apparatuses, and non-transitory computer-readable medium described herein, communicating the packet may include operations, features, means, or instructions for receiving via the first service class, the packet from the device, inserting, into a header of the packet, a traffic identifier that corresponds to the first service class based on the mapping information, and transmitting, to the second network device, the packet that includes the traffic identifier.

In some examples of the method, apparatuses, and non-transitory computer-readable medium described herein, the traffic identifier may be a VLAN tag.

In some examples of the method, apparatuses, and non-transitory computer-readable medium described herein, translating the header of the packet may include operations, features, means, or instructions for receiving the packet from the second network device, the packet including the first network address, replacing the first network address with the second network address that may be mapped to the first network address via the mapping information, and where the packet may be transmitted to the device via the first service class.

In some examples of the method, apparatuses, and non-transitory computer-readable medium described herein, translating the header of the packet may include operations, features, means, or instructions for receiving, the packet from the device, the packet including the second network address, replacing the second network address with the first network address that may be mapped to the second network address via the mapping information, and where the packet may be transmitted to the second network device.

Some examples of the method, apparatuses, and non-transitory computer-readable medium described herein may further include operations, features, means, or instructions for scheduling communication of a set of multiple packets including the packet based on a respective service class associated with each of the set of multiple packets and where the packet may be communicated based on the scheduling.

In some examples of the method, apparatuses, and non-transitory computer-readable medium described herein, the mapping information may be received via a dynamic host configuration protocol (DHCP) message, or a serial communication, or a HTTP.

In some examples of the method, apparatuses, and non-transitory computer-readable medium described herein, the mapping information may be received by a DHCP client at the first network device and via a DHCP offer message that may be transmitted by a DHCP server at the second network device and the DHCP offer message includes the mapping information and indicates an identifier configured to cause the DHCP client to refrain from discarding the DHCP offer message.

Some examples of the method, apparatuses, and non-transitory computer-readable medium described herein may further include operations, features, means, or instructions for receiving the mapping information includes an indication of one or more QoS identifiers that may be mapped to a service class of the set of multiple service classes, description information associated with each QoS flow, a packet filter set per QoS flow, or any combination thereof.

In some examples of the method, apparatuses, and non-transitory computer-readable medium described herein, receiving the mapping information includes receiving description information that indicates a maximum flow bit rate per QoS flow, a guaranteed flow bit rate per QoS flow, an averaging window per QoS flow, the QoS identifier per QoS flow, or a combination thereof.

In some examples of the method, apparatuses, and non-transitory computer-readable medium described herein, the mapping information does not include information associated with an ethernet port of the first network device.

In some examples of the method, apparatuses, and non-transitory computer-readable medium described herein, the first network device and the second network device may be included in a customer premises equipment (CPE).

In some examples of the method, apparatuses, and non-transitory computer-readable medium described herein, the first RAT may be cellular communications technology and the second RAT may be Wi-Fi.

### BRIEF DESCRIPTION OF THE DRAWINGS

FIG. 1 illustrates an example of a wireless communications system that supports end-to-end quality of service (QoS) via a customer premises equipment (CPE) in accordance with one or more aspects of the present disclosure.

FIG. 2 illustrates an example of a wireless communications system that supports end-to-end QoS via a CPE in accordance with one or more aspects of the present disclosure.

FIG. 3 illustrates an example of a wireless communication architecture that supports end-to-end QoS via a CPE in accordance with one or more aspects of the present disclosure.

FIG. 4 illustrates an example of a CPE architecture that supports end-to-end QoS via a CPE in accordance with one or more aspects of the present disclosure.

FIG. 5A and FIG. 5B illustrate an example of a process flow that supports end-to-end QoS via a CPE in accordance with one or more aspects of the present disclosure.

FIG. 6A, FIG. 6B, and FIG. 6C illustrate an example of a process flow that supports end-to-end QoS via a CPE in accordance with one or more aspects of the present disclosure.

FIGS. 7 and 8 illustrate block diagrams of devices that support end-to-end QoS via a CPE in accordance with one or more aspects of the present disclosure.

FIG. 9 illustrates a block diagram of a communications manager that supports end-to-end QoS via a CPE in accordance with one or more aspects of the present disclosure.

FIG. 10 illustrates a diagram of a system including a device that supports end-to-end QoS via a CPE in accordance with one or more aspects of the present disclosure.

FIGS. 11 and 12 illustrate block diagrams of devices that support end-to-end QoS via a CPE in accordance with one or more aspects of the present disclosure.

FIG. 13 illustrates a block diagram of a communications manager that supports end-to-end QoS via a CPE in accordance with one or more aspects of the present disclosure.

FIG. 14 illustrates a diagram of a system including a device that supports end-to-end QoS via a CPE in accordance with one or more aspects of the present disclosure.

FIGS. 15 through 17 illustrate flowcharts showing methods that support end-to-end QoS via a CPE in accordance with one or more aspects of the present disclosure.

### DETAILED DESCRIPTION

Some wireless communications systems may support local networks, such as a Wi-Fi networks. For example, a cellular device, such as a UE may communicate with a network entity using a first radio access technology (RAT), and support communications with other devices via a second RAT, such as Wi-Fi. In some examples, communications via the first RAT and/or the second RAT may be associated with a quality of service (QoS) requirements or service classes that are associated with different QoSs. For example, Wi-Fi networks may support voice over internet protocol (VOIP), high definition (HD) video, gaming, etc., each of which may be associated with different QoS requirements and parameters. Additionally, communications via cellular networks, such as networks implementing 5G RAT communications, may be associated with different QoS flows each of which may be associated with a different value for a set of parameters, such as 5G delay budget, packet error rate, priorities, etc.

In some examples, a 5G customer premises equipment (CPE) may support Wi-Fi access via a 5G wireless backhaul, such that the CPE may provide connectivity via 5G communications (e.g., a first RAT) and such that the CEP may provide connectivity via Wi-Fi communication protocols. Techniques described herein support an end-to-end (e.g., core network to user device via Wi-Fi) QoS architecture and QoS coordination via both Wi-Fi and 5G protocols to support consistent QoS traffic. The QoS requirements may be driven by the core 5G network or by the Wi-Fi network. Depending on whether the QoS is driven by the core network or the WIFI network, various signaling techniques are described herein. A cellular modem (e.g., a user equipment (UE)) may be signaled with the QoS flows using various QoS parameters, such as delay budget, error rate, and priority.

The cellular modem may map the 5G QoS parameters to Wi-Fi service classes based on the service class parameters (e.g., delay bound, priority) and the 5G QoS parameters. The mapping information, which may include the service class to QoS mapping, IP addresses associated with the QoS flows, and other information, may be communicated to the Wi-Fi router using various types of signaling, depending on the capabilities of the modem and router and whether the modem and router are configured within the same CPE (e.g., the same box). The Wi-Fi router is configured to support local IP to public IP mapping based on the received mapping information, traffic indicator tagging (e.g., using virtual local area network (VLAN) tagging), and packet scheduling, to support routing packets in uplink and downlink to support the QoS flows and Wi-Fi service types.

For example, a first network device, such as a cellular modem, may transmit to a second network device, such as a router, mapping information that indicates a mapping of each QoS flow of a plurality of QoS flows of a first RAT (e.g., cellular) to one or more service classes of a plurality of service classes of a second RAT (e.g., Wi-Fi). The mapping may be based on the set of QoS parameter values for the plurality of QoS flow. The first network device and the second network device may communicate a packet between a first QoS flow and a second QoS flow based on the mapping. By supporting mapping of QoS flows to service classes, the techniques may support improved communication efficiency and reliability at user devices. More particularly, because the QoS flows and the service classes may be associated with minimum reliability and throughput parameter values, and such parameter values may be used to map QoS flows to service types, the communication reliability and throughput targets may be maintained for end-to-end (e.g., user device to application server) communications.

Additionally, the QoS flow setup and mapping may be initiated by the communication facilities that may communicate via the first RAT or by a user device or the second network device that may communicate via the second RAT. For example, the first network device may receive control signaling via the first RAT, and the control signaling may indicate a set of QoS parameter values per QoS flow a plurality of QoS flows. The first network device may then dynamically map the QoS flows to one or more service classes of the second RAT. Additionally, or alternatively, the first network device may transmit a request (e.g., via uplink control signaling) for a change or addition of a QoS flow based on communication received from the second network device. More particularly, if the first network device receives an uplink communication for a default QoS flow, then the use of the default QoS flow may trigger a dynamic addition of a new QoS flow to support communications. As such, QoS flows may be dynamically added based on server (e.g., application server) and/or device needs, which may result in improved communication flexibility, reliability, and throughput. These and other techniques are described in further detail with respect to the figures.

Aspects of the disclosure are initially described in the context of wireless communications systems. Aspects of the disclosure are further described with respect to a wireless communications system, wireless communications architecture diagrams, and process flow diagrams. Aspects of the disclosure are further illustrated by and described with reference to apparatus diagrams, system diagrams, and flowcharts that relate to end-to-end QoS via a CPE.

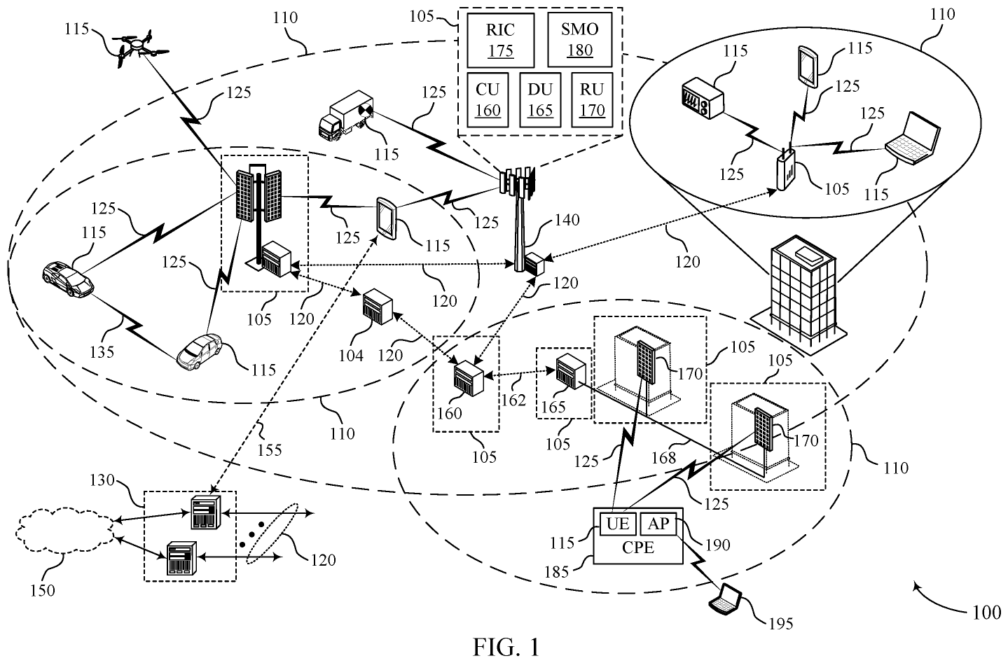

FIG. 1 illustrates an example of a wireless communications system 100 that supports end-to-end QoS via a CPE in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support end-to-end QoS via a CPE as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, the wireless communications system 100 may support a CPE 185, which may communicate with the wireless communications system 100 via UE 115 that communicates with a network entity 105 via a first RAT (e.g., cellular communications) and may also communicate with other devices, such as STA 195, via a second RAT (e.g., Wi-Fi) to support local network communications. For example, the CPE 185 may implement a UE 115, which may communicate with the network and function as a cellular modem, and an AP 190, which may function to support a wireless local area network (WLAN) (also known as a Wi-Fi network), as a router. The WLAN may include the AP 190 and multiple associated stations (STAs), such as STA 195, which may represent devices such as mobile stations, personal digital assistant (PDAs), other handheld devices, netbooks, notebook computers, tablet computers, laptops, display devices (e.g., TVs, computer monitors, etc.), printers, etc. STAs 195 and APs 190 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

The wireless communications system 100 may support various QoS flows for a first RAT (e.g., cellular communications), each of which may be associated with a different set of parameter values for a set of QoS parameters. The Wi-Fi network of the AP 190 may also support different service types. As described herein, to support end-to-end (e.g., core network 130 to STA 195) QoS communications, a first network device (e.g., a cellular modem or a UE 115 of the CPE 185) may receive control signaling indicating a set of QoS parameter values per QoS flow of a plurality of QoS flows. The cellular modem may map each QoS flow to a service class of a plurality of QoS classes of the second RAT (e.g., Wi-Fi). The mapping may be based on the parameters associated with the QoS flows parameters of the service classes. The cellular modem may communicate the mapping information that indicates the mapping of each QoS flow to a service classes then communicate a packet between a QoS flow and a service class based on the mapping.

A second network device, such as a router (e.g., the AP 190) may receive the mapping information and use the information to communicate packets between the cellular modem and a device (e.g., STA 195) based on the service types. The second network device may translate network addresses (e.g., internet protocol (IP) addresses) between public IP addresses and private IP addresses based on the mapping information and may also add virtual local area network (VLAN) tags (e.g., network identifiers) to support routing of packets to the correct service types and QoS flows. Additionally, the router may implement a scheduler to schedule packets based on the service types. As such, according to these techniques, the cellular modem, the router, and the network may work in conjunction to support end-to-end QoS communications.

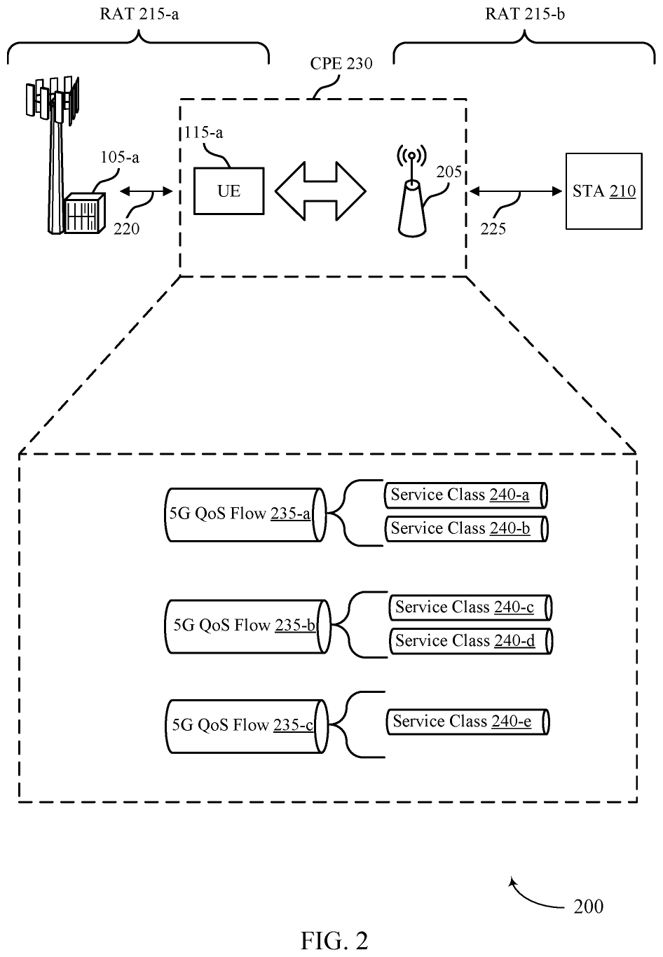

FIG. 2 illustrates an example of a wireless communications system 200 that supports end-to-end QoS via a CPE in accordance with one or more aspects of the present disclosure. The wireless communications system 200 may include one or more aspects of the wireless communications system 100. For example, the wireless communications system 200 may include a network entity 105-a, a UE 115-a, an AP 205, and a STA 210, which may be respective examples of a network entity 105, a UE 115, an AP 190, and a STA 195 as described with reference to FIG. 1. In some examples, the network entity 105-a and the UE 115-a may communicate via a link 220 according to a RAT 215-a (e.g., 5G) and the AP 205 and the STA 210 may communicate via a link 225 according to a RAT 215-b (e.g., Wi-Fi). Further, the wireless communications system 200 may include a CPE 230, which may support mapping QoS flows (e.g., QoS flows 235) to service classes (e.g., service classes 240) and communications based on the mapping between the RAT 215-a and the RAT 215-b, as described with reference to FIG. 1.

In some communications systems, the UE 115-a may support communications with the network entity 105-a as well as the AP 205. That is, the UE 115-a may provide a connection to the RAT 215-a (e.g., cellular communications with the network entity 105-a) and may provide a connection to the RAT 215-b (e.g., a Wi-Fi protocol). Such connections may be supported by the CPE 230, which may include a modem, a router, or both, to facilitate end-to-end QoS coordination between the RAT 215-a and the RAT 215-b. In some examples, the end-to-end coordination may be driven by the RAT 215-a (e.g., 3GGP driven or core network driven) or may be driven by the RAT 215-b (e.g., Wi-Fi network driven).

To support such coordination, the CPE 230 may function to map service classes 240 to QoS flows 235. The CPE 230 may determine such mappings based on various parameters associated with each of the QoS flows 235 and the service classes. Accordingly, the CPE 230 may map the QoS flow 235 parameters of the RAT 215-a to a set of service class 240 parameters associated with the RAT 215-b. It should be noted that any quantity of mappings may be performed by the CPE 230, and is not limited to the quantity illustrated by the wireless communications system 200.

In some examples, the CPE 230 may operate according to various architectures. For example, the CPE 230 may operate according to an internet protocol (IP) protocol data unit (PDU) session-based CPE architecture or an ethernet PDU session-based architecture. In some cases, such as when the CPE operates according to the IP PDU session-based architecture, the CPE 230 may further use a call flow for static PCC rules-based end-to-end QoS establishment, a call flow for dynamic PCC rules-based end-to-end QoS establishment, or both. In some other cases, such as when CPE operates according to the ethernet PDU session-based architecture, the CPE 230 may further use a call flow for a static PCC rules-based end-to-end QoS establishment, a call flow for a dynamic PCC rules-based end-to-end QoS establishment, or both. Additionally, or alternatively, the CPE 230 (e.g., the AP 205) may use a VLAN mapping configuration to route packets according to various mapped QoS and service types.

Shown below, Table 1 may include various architectural elements end to end QoS.

TABLE 1

| Architectural | RAT 215-a | RAT 215-b |
|---|---|---|
| Element | (e.g., 5G) | (e.g., Wi-Fi) |
| QoS Definition | Cellular QoS | Service Type QoS |
| QoS Policy | Policy Control | Service Type Manager |
| Configuration | Function (PCF) | |
| and Control | | |
| QoS Signaling | Application Server | Network Initiated via |
| | Initiated via PCF | Service Type Manager |
| | UE Initiated | Wi-Fi STA Initiated |
| Packet Filters | Downlink at User Plane | Downlink at AP |
| | Function (UPF) | |
| | Uplink at UE | |
| QoS Flow | Map Wi-Fi Uplink QoS | Map Cellular Downlink |
| Queuing | Flows to Cellular Uplink | QoS Flows to |
| | QoS Flows | Wi-Fi Downlink |
| | | QoS Flows |
| QoS | Downlink: Per QoS Flow | Downlink: Per QoS |
| Scheduling | at Network Entity | Flow at AP |
| | Uplink: Per QoS Flow at | Uplink: Per Peer-traffic |
| | Network Entity and UE | identifier (TID) at AP |

The architectural elements of Table 1 may correspond to a respective definition for the RAT 215-a and the RAT 215-b. For example, according to Table 1, QoS signaling may be initiated by an application server via a PCF of the RAT 215-a, which may correspond to QoS signaling initiated by a network via a service type manager of the RAT 215-b. In some examples, the RAT 215-a and the RAT 215-b may have different quantities of mapping operations for an architectural element, such as packet filters (e.g., no corresponding uplink packet filters for RAT 215-b).

In some examples, QoS parameters of the RAT 215-a may be mapped to parameters of the QoS parameters RAT 215-b. In some examples, the CPE 230 (e.g., the UE 115-a) maps the parameters or uses a parameter mapping table to perform the mappings of QoS flows 235 to service classes 240. Example parameter mappings are shown in Table 2, below:

TABLE 2

| RAT 215-a (e.g., | RAT 215-b (e.g., |
|---|---|
| cellular) QoS Parameters | Wi-Fi) QoS Parameters |
| Cellular QoS Identifier | Delay Bound |
| (5QI) Delay Budget | |
| 5QI Packet Error Rate (PER) | Packet Loss Ratio |
| 5QI Priority | Transmission Opportunity |
| | (TXOP) Scheduling Priority |
| Guaranteed Bit Rate (GBR) | Minimum and Maximum |
| | Throughput |
| Maximum Data Burst Volume (MDBV) | Burst Size |
| Allocation and Retention Policy (ARP) | Admission Control Priority |
| Periodicity | Service Interval |

In some cases, a non-access stratum (NAS) PDU session modification command may include mappings for one or more of the QoS parameters. In one example, the NAS PDU session modification command may include the 5QI delay budget mapping, the 5QI PER mapping, the 5QI priority mapping, the GBR mapping, or any combination thereof. Additionally, the UE 115-a may identify the mappings included in the NAS PDU session modification command based on a network configuration. For instance, the mappings included in the NAS PDU session modification command may be identifiable by (e.g., indirectly visible to) the UE 115-a when a standardized 5QI is used by the network. Alternatively, the UE 115-a may identify the mappings based on the mappings being signaled to the network entity 105-a. Further, the UE 115-a may identify the MDBV mapping when the MDBV mapping is included in the 5QI configuration. In some examples, the ARP mapping and the periodicity mapping may not be identifiable by (e.g., visible to) the UE 115-a. However, in some examples, the ARP and periodicity may be available.

Example types of services that may be supported by RAT 215-a and RAT 215-b that may be supported via QoS flow 235 to service class 240 mappings are shown in Table 3 below:

TABLE 3

| RAT 215-b Service Class | RAT 215-a 5QI |
|---|---|
| Augmented Reality (AR)/Virtual | |
| Reality (VR) Service | |
| Gaming Service | Real-Time Gaming, Vehicle- |
| | to-Everything (V2X) |
| Interactive Video | Conversational Video |
| Interactive Audio | Conversational Voice |
| Streaming Video or Video-on- | Non-conversational Video |
| Demand (VOD) Service | |
| Voice Over Internet Protocol | Conversational Voice |
| (VOIP) Service | |
| Time Sensitive Control Traffic | IP Multimedia Subsystem |
| | (IMS) Signaling |
| Large File Transfers or | General GBR or non-GBR |
| Data Movement | |

In some cases, the service mappings shown included in Table 3 may indicate various applications associated with the RAT 215-b and the RAT 215-b and service class (e.g., relative QoS priority) mappings for the applications. For example, a service class associated with AR or VR service in the RAT 215-b (e.g., Wi-Fi) may not have a corresponding mapping to the RAT 215-a, which may indicate that no service of the RAT 215-a corresponds to a relatively high expected QoS (e.g., service class) of the AR or VR service. As another example, large file transfers or data movement in the RAT 215-a may correspond to a general GBR or non-GBR of the RAT 215-b, which may indicate services associated with a relatively low expected QoS. In some cases, the CPE 315 may convert Wi-Fi IP tuples to cellular side port numbers (e.g., associated with the UE 115-a), which may be an example of a network address translation (NAT) function. Such mappings and translations may support end-to-end QoS between applications of the RAT 215-a and the RAT 215-b without dynamically defining a service class for each application.

Table 4 below includes example CPE 230 QoS flow signaling options between the RAT 215-b and the RAT 215-a to support end to end QoS:

TABLE 4

| | | Dynamic | Static |
|---|---|---|---|
| 3GPP/ | Application | Triggered by | |
| Core | Server | Application Server | |
| Network | Initiated | Administered by PCF | |
| Driven | QoS | Signaled to Network | |
| | | Entity and UE | |
| | | Transferred from UE | |
| | | to Wi-Fi-AP | |
| | | Applicable to Downlink | |
| | | and Uplink | |
| | PCF | | Administered by PCF |
| | Initiated | | Signaled to Network |
| | QoS | | Entity and UE |
| | | | Map Wi-Fi QoS |
| | | | flows to 5G flows |
| Wi-Fi | Wi-Fi | Triggered by Wi-Fi | |
| Network | Network | Network Operator | |
| Driven | Controller | Signaled to Session | |
| | Initiated | Management Function | |
| | QoS | (SMF) or PCF | |
| | | Applicable to Downlink | |
| | | and Uplink | |
| | Wi-Fi Client | Triggered by Wi-Fi STA | |
| | Initiated | Signaled to AP, UE, and | |
| | QoS | SMF or PCF | |
| | | Administered by PCF | |
| | | Applicable to Downlink | |
| | | and Uplink | |

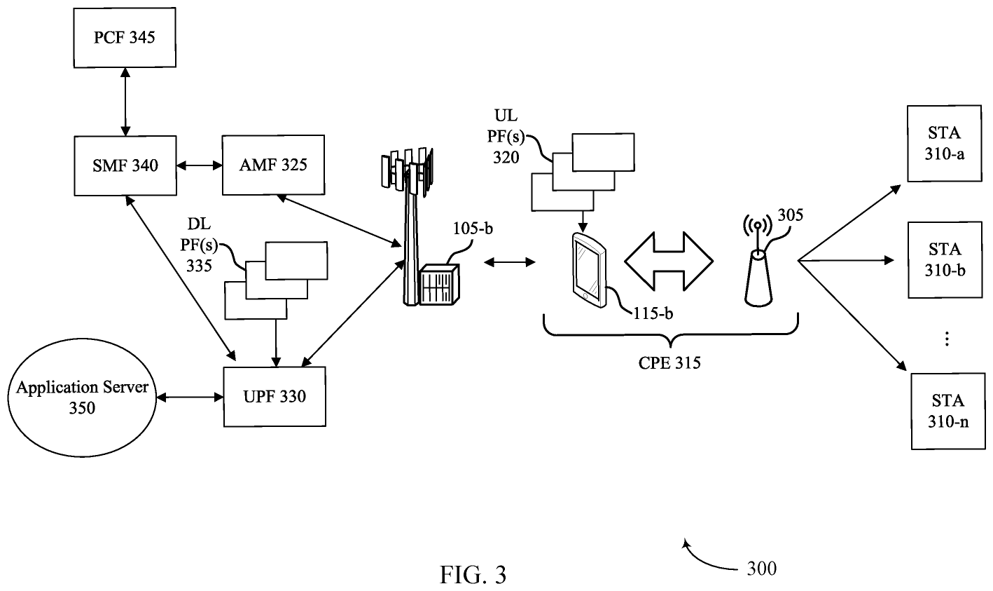

FIG. 3 illustrates an example of a wireless communications architecture 300 that supports end-to-end QoS via a CPE in accordance with one or more aspects of the present disclosure. The wireless communications architecture 300 may implement one or more aspects of the wireless communications system 100 and the wireless communications system 200. For example, the wireless communications architecture may support end-to-end QoS mapping between a first RAT (e.g., cellular communications, 5G) and a second RAT (e.g., Wi-Fi protocol), as described with reference to FIG. 2. Additionally, the wireless communications architecture may include a CPE 315, which may be an example of the CPE 230 as described with reference to FIG. 2.

In some examples, the wireless communications architecture 300 may implement a static QoS configuration from a PCF 345. That is, the CPE 315 may request QoS in the first RAT based on static rules (e.g., independent from an application server 350). In one example, the rules may be configured in the first RAT, and QoS establishment may be triggered from the first RAT. Alternatively, the rules may be configured in a fixed wireless access (FWA) UE 115-b or an AP 305, and QoS establishment may be triggered from the first RAT using an existing PDU session modification procedure. In some cases, the PDU session modification procedure may be the same as a UE 115-b initiated QoS signaling procedure (as shown in Table 1).

The static rules (e.g., policies) for QoS may be pre-configured by the PCF 345 for various types of application traffic (e.g., identified from IP address ranges, port numbers, or both). The PCF 345 may communicate within the first RAT in order to install one or more packet filters and to establish a QoS flow for the first RAT. That is, the PCF 345 may provide uplink packet filters 320 to the UE 115-b, downlink packet filters 335 to a UPF 330, or both, which may support aggregating multiple QoS flows from the second RAT to be mapped to a common QoS flow for the first RAT. For example, the static rules (e.g., translation rules) may limit a quantity of QoS flows of the first RAT such that a packet filter of a statically provisioned QoS flow may accommodate multiple dynamically established QoS flows of the second RAT. In some examples, the packet filter may be specified to provide broad coverage of common parts of potential QoS flows of the second RAT to be mapped to QoS flows of the first RAT. In one example, application traffic from a service (e.g., a streaming provider) of the second RAT may share a same set of server-side IP addresses, a same range of port numbers, or both, and such sets may be used as the packet filter of the QoS flow of the first RAT (e.g., a QoS flow carrying the application traffic). Additionally, or alternatively, a first application of the second RAT (e.g., a file transfer protocol (FPT) traffic session) and a second application of the second RAT (e.g., a VOIP traffic session) may be associated with different port number ranges on the server-side. Accordingly, the first application and the second application may be split into different QoS flows of the first RAT using the service-side port number ranges, and may be split into QoS flows of the second RAT corresponding to different service classes.

In some examples, such as when the UE 115-b has the uplink packet filters 320 installed, the UE 115-b may perform a NAT function to map tuples of the second RAT to transport ports of the first RAT. Additionally, the UE 115-b may map uplink QoS flows of the second RAT to QoS flows of the first RAT, and the AP 305 may map downlink QoS flows of the first RAT to QoS flows of the second RAT. In some examples, a STA 310 may signal downlink classification rules or uplink classification rules (e.g., translation rules) to the AP 305, which may support a self-aware Wi-Fi configuration for QoS flows of the second RAT.

In some cases, per-packet mapping between a QoS flow of the first RAT and a QoS flow of the second RAT may be determined via a NAT function and the static QoS flow packet filters. The mappings may support a many-to-one configuration for translating one or more service classes of the second RAT to one or more QoS flows of the first RAT. For example, a delay bound, service interval, and packet loss rate (e.g., corresponding to service classes of the second RAT) may be mapped to a packet delay budget (PDB), a semi-persistent scheduling (SPS) period, and a maximum packet loss rate associated with the QoS flows. In some cases, the mapping may prioritize matching service classes to the PDB, then to the SPS period, and then to the packet loss rate associated with 5QI service classes. That is, the CPE 315 may map aggregate data from the second RAT to similar parameters of the first RAT in order to combine the aggregate data in a single service class of the first RAT. In some cases, a TID of the second RAT may be determined based on a QoS of the second RAT.

Shown below, Table 5 may include various functions for implementing a static PCF based end-to-end QoS mapping.

TABLE 5

| Component | Function(s) |
|---|---|
| Cellular/Core | PCF Creates Preconfigured Static |
| Network | Cellular QoS Flow for CPE |
| | PCF Signals UPF and UE of Packet |
| | Filters for QoS Flows |
| | UPF Creates Downlink Packet Filters |
| | Per PCF Request |
| | PCF Signals Cellular QoS Parameters to |
| | Network Entity |
| | Network Entity Performs Downlink and |
| | Uplink QoS Scheduling |
| UE 115-b | UE Creates Uplink Packet Filters Per PCF |
| | Request |
| | UE Gives Packet Filters and Downlink/Uplink |
| | Cellular QoS Parameters to AP |
| | UE Maps Uplink Wi-Fi QoS Flows Into |
| | Cellular QoS Flows |
| AP 305 | AP Creates QoS Requirements Per Wi-Fi |
| | Network Operator Configuration |
| | AP Creates Downlink Packet Filters Per STA |
| | Request |
| | AP Performs Downlink and Uplink |
| | Scheduling According to QoS |
| | AP Maps Downlink Cellular QoS Flows to |
| | Wi-Fi QoS Flows |
| STA 310 | STA Signals Packet Filters and QoS |
| | Parameters to AP |

In some other examples, the wireless communications architecture 300 may be an example of a dynamic QoS configuration initiated by an application server 350. For example, the application server 350 may identify end-to-end application traffic (e.g., application traffic communicated by a STA 310 and the application server 350) and may determine a QoS flow of the application traffic. For example, application traffic by the STA 310 may use a default QoS flow, for an uplink packet, and use of the default QoS flow may signal the application server 350 to dynamically cause generation of one or more QoS flows. The application server 350 may identify an IP address, a port number, or both associated with the application traffic and may send a request to the PCF 345 to apply QoS for the application traffic (using techniques similar to those in the static configuration). In such examples, a QoS mapping may be one-to-one such that a tuple of the second RAT (e.g., an IP5 tuple) corresponds to a specific tuple of the first RAT (e.g., a 5QI tuple). That is, QoS mappings may be dynamically generated by the UE 115-b (e.g., according to the uplink packet filters 320) to be applied to the identified application traffic. The UE 115-b may then map QoS flows of the first RAT to QoS flows (service classes) of the second RAT, and may transmit a signal to the AP 305 indicating the application traffic (e.g., indicating the mapping information). After receiving the signal, the AP 305 may perform QoS scheduling for the second RAT (e.g., Wi-Fi downlink and uplink).

Shown below, Table 6 may include various functions for implementing a dynamic application server initiated end-to-end QoS mapping.

TABLE 6

| Component | Function(s) |
|---|---|
| Cellular/Core | PCF Configures Cellular QoS Flow Per |
| Network | Application Server Request |
| | PCF Signals UPF and UE of Packet Filters for |
| | QoS Flows |
| | UPF Creates Downlink Packet Filters Per PCF |
| | Request |
| | PCF Signals Cellular QoS Parameters to |
| | Network Entity |
| | Network Entity Performs Downlink and Uplink |
| | QoS Scheduling |
| UE 115-b | UE Creates Uplink Packet Filters Per PCF |
| | Request |
| | UE Gives Packet Filters and Downlink/Uplink |
| | Cellular QoS Parameters to AP |
| AP 305 | AP Converts Cellular QoS to Wi-Fi QoS |
| | AP Creates Downlink Packet Filters Per UE |
| | Request |
| | AP Performs Downlink and Uplink Scheduling |
| | According to QoS |
| | AP Signals Uplink Packet Filters and Wi-Fi |
| | QoS Parameters to STA |
| STA 310 | STA Creates Uplink Packet Filters Per AP |
| | Request |
| | STA Performs Downlink and Uplink Scheduling |
| | Per AP Request |

In another example, the wireless communications architecture 300 may be an example of a dynamic QoS configuration initiated by the UE 115-b, the AP 305, a STA 310, or any combination thereof. That is, the QoS configuration may be triggered by the UE 115-b transmitting a request to the PCF for end-to-end application traffic to have QoS rules applied (e.g., translation rules). In some cases, the AP 305 may receive an indication of the end-to-end application from a STA 310, and may forward the indication to the UE 115-b to trigger to request to the PCF. Additionally, the AP 305 may perform a mapping between QoS flows of the second RAT (e.g., WLAN service classes) to QoS flows of the first RAT (e.g., 5QI) and may signal the mapping to the UE 115-b.

Shown below, Table 7 may include various functions for implementing a dynamic UE or AP based end-to-end QoS mapping.

TABLE 7

| Component | Function(s) |
|---|---|
| Cellular/Core | PCF Configures Cellular QoS Flow Per UE |
| Network | Request |
| | PCF Signals UPF and UE of Packet Filters for |
| | QoS Flows |
| | UPF Creates Downlink Packet Filters Per PCF |
| | Request |
| | PCF Signals Cellular QoS Parameters to |
| | Network Entity |
| | Network Entity Performs Downlink and |
| | Uplink QoS Scheduling |
| UE 115-b | UE Allows Configuration from AP for Cellular |
| | Downlink/Uplink QoS Flows |
| | UE Initiates Cellular QoS Flow Creation with |
| | SMF/PCF |
| | UE Creates Uplink Packet Filters Per PCF |
| | Request |
| AP 305 | AP Creates QoS Requirements Per Network |
| | Operator Configuration |
| | AP Creates Downlink Packet Filters Per UE |
| | Request |
| | AP Performs Downlink and Uplink Scheduling |
| | According to QoS |
| | AP Converts Wi-Fi QoS to Cellular QoS |
| | AP Gives Packet Filters and Downlink/Uplink |
| | Cellular QoS Parameters to UE |
| STA 310 | STA Signals Packet Filters and QoS |
| | Parameters to AP |

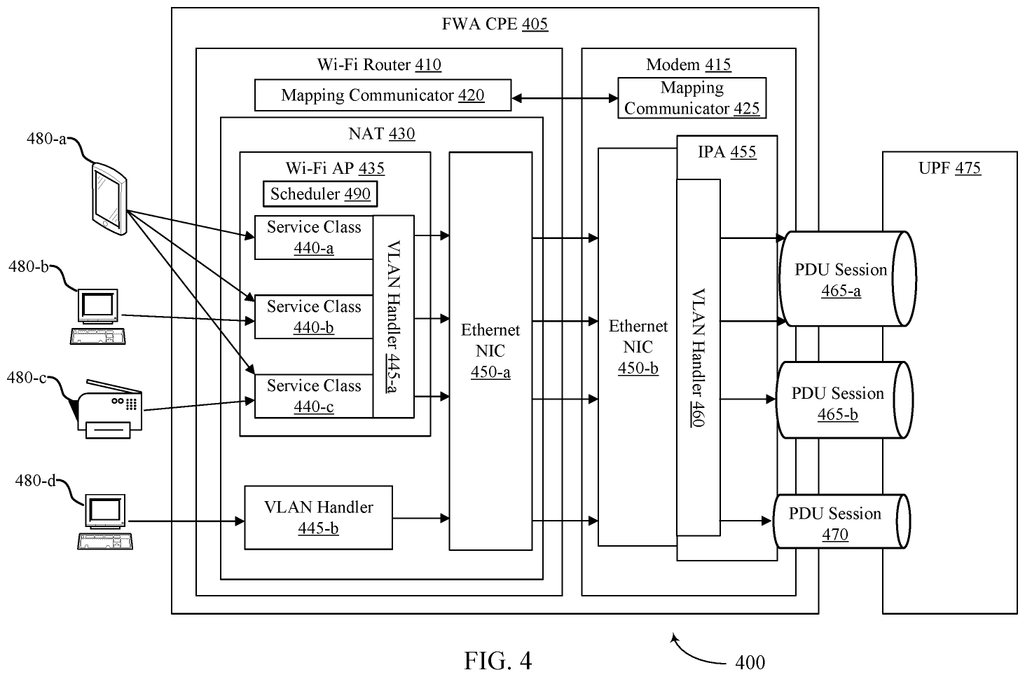

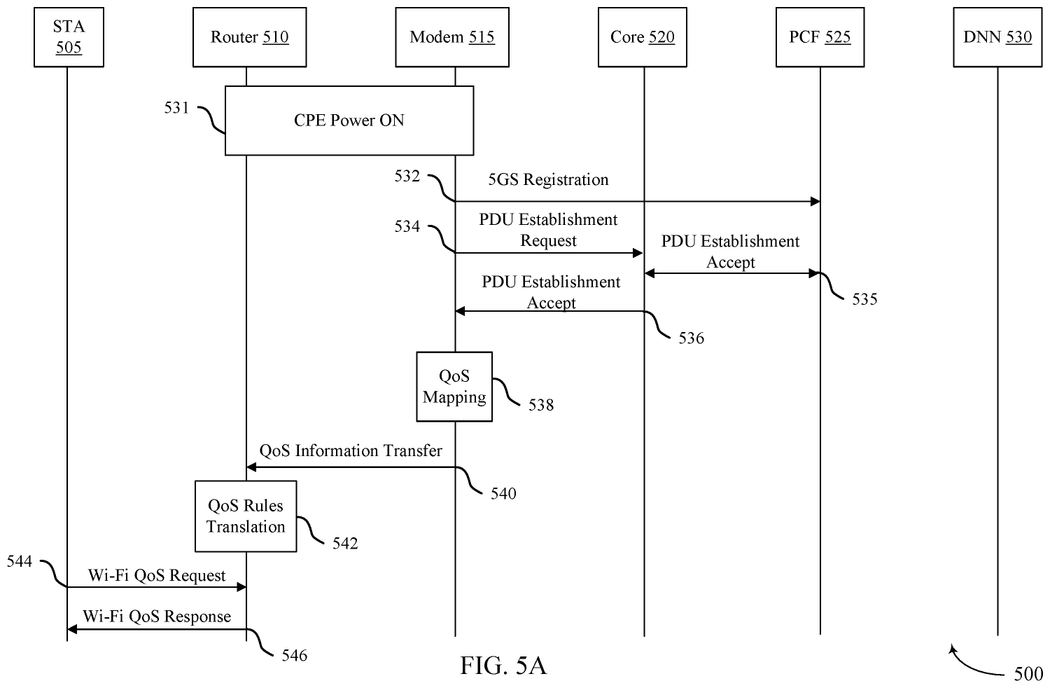

FIG. 4 illustrates an example of a CPE architecture 400 that supports end-to-end QoS via a CPE in accordance with one or more aspects of the present disclosure. The CPE architecture 400 may be implemented by one or more aspects of the wireless communications system 200 and the wireless communications architecture 300. For example, the CPE architecture 400 may include a fixed wireless access (FWA) CPE 405, which may be an example of the CPE 315 and the CPE 315 as described with reference to FIG. 2 and FIG. 3, respectively. Additionally, the CPE architecture 400 may include a UPF 330, which may be an example of the UPF 330 as described with reference to FIG. 3. In some cases, the CPE architecture 400 may be an example of an IP PDU session based architecture. In some other cases, the CPE architecture 400 may be an example of an ethernet PDU session based architecture.

In some cases, the FWA CPE 405 may include a Wi-Fi router 410 (e.g., an AP or a network device) and a cellular modem 415 (e.g., a UE 115 or a network device), which may facilitate mappings of QoS flows between a first RAT associated with the cellular modem 415 (e.g., 5G NR, a different cellular protocol) and a second RAT associated with the Wi-Fi router 410 (e.g., a Wi-Fi protocol). Additionally, the Wi-Fi router 410 and the cellular modem 415 may include a mapping communicator 420 (e.g., a dynamic host configuration protocol (DHCP) client, a hypertext transfer protocol (HTTP) client, a serial port, or the like) and a mapping communicator 425 (e.g., a DHCP server, an HTTP server, a serial port, or the like), respectively, which may transfer mapping information between the Wi-Fi router 410 and the cellular modem 415. The Wi-Fi router 410 may include a NAT 430 (e.g., corresponding to a function to support establishing a network), which may further include an AP 435. In some cases, the Wi-Fi router 410 may facilitate scheduling of application traffic within the second RAT and service classes 440 of the second class via a scheduler 490. That is, one or more STAs 480 (e.g., a STA 480-a, a STA 480-b, a STA 480-c, and a STA 480-d) may communicate (e.g., receive or transmit) data (e.g., application data) via the second RAT, and the data may be communicated via one or more service classes by the scheduler 490 (e.g., communicated according to parameters associated with a service class). For example, communications by the STA 480-a may be classified to each of a service class 440-a, a service class 440-b, and a service class 440-c (e.g., transmitting application data with various QoS expectancies), communications by the STA 480-b may be classified to the service class 440-b, and communications by the STA 480-c may be classified to the service class 440-c. In some cases, the STA 480-d may communicate within the second RAT via an ethernet connection, and thus may not be classified into a service class or a QoS flow. Further, the NAT 430 may additionally support one or more translations for QoS rules. For example, the NAT 430 may provide a translation from a public IP or port number of the cellular network to a private IP or port number of the Wi-Fi network based on translation rules. The mappings of port numbers (e.g., IP packet filters) may be examples of mapping information that is communicated between the modem 415 and the router 410 and may be used to configure the translation rules

In some examples, the AP 435 may manage VLAN tags associated with application data via a VLAN handler 445-a. Operations of the VLAN handler 445-a may be associated with a communication direction of the application data. That is, the VLAN handler 445-a may insert a VLAN tag for uplink application data (e.g., to be mapped to a QoS flow of the first RAT), or may remove a VLAN tag for downlink application data (e.g., mapped to a QoS flow of the second RAT). In some cases, the VLAN handler 445-a may manage VLAN tags for an uplink ethernet frame (e.g., one STA 480 associated with one service class and one IP PDU session). Additionally, or alternatively, a mapping between a STA 480 and a VLAN tag may be pre-configured, or may be dynamically determined (e.g., dynamic learning). In some examples, the mapping of DNN types for STA use and the VLAN tags are examples of mapping information that is communicated between the modem 415 and the router 410.

In order to map QoS parameters between the Wi-Fi router 410 and the cellular modem 415, the mapping communicator 420 may coordinate mapping information with the mapping communicator 425. In the case of the FWA CPE 405 operating according to an IP PDU session based architecture, the mapping communicator 420 may be an example of a DHCP client. Alternatively, in the case of the FWA CPE 405 operating according to an ethernet PDU session based architecture, the mapping communicator 420 may be an example of a DHCP client or an HTTP client.

The scheduler 490 may use mapping information for end-to-end QoS treatment. For example, the scheduler 490 may establish a QoS flow for the second RAT using a mapped QoS flow description received from the cellular modem 415. In some cases, the scheduler 490 may provide enforcement of translation rules (e.g., an IP packet filter set provided by the NAT 430) when scheduling communications for one or more STAs 480. Additionally, transmissions from a STA 480 may be associated with multiple service classes, which may be associated with a same PDU session. In another example, transmissions from the STA 480 may be associated with multiple service classes, which may be associated with a different PDU session. In such examples, the Wi-Fi AP 435 may perform a deep packet inspection (DPI) to map different applications of the STA 480 to different PDU sessions (e.g., applications associated with different VLAN tags).

In some cases, the NAT 430 may communicate with the cellular modem 415 via an ethernet network interface controller (NIC) 450-a and an ethernet NIC 450-b. For example, the VLAN handler 445-a may output one or more QoS flows with corresponding VLAN tags to the ethernet NIC 450-a, which may communicate with the ethernet NIC 450-b (e.g., included in the cellular modem 415).

The cellular modem 415 may facilitate QoS flow mappings via a mapping function. For example, the cellular modem 415 may include an internet packet accelerator (IPA) 455 to support reception of QoS flows with corresponding VLAN tags (e.g., received via the ethernet NIC 450-b), and the IPA 455 may include a VLAN handler 460. In some examples, the VLAN handler 460 may map a VLAN tag to a PDU session, such as a PDU session 465-a, a PDU session 465-b, or a PDU session 470, via the mapping function and based on mapping information received from the modem 415. In some examples, the mapping function may use a pre-configured mapping table (e.g., mapping information) providing mappings between QoS flows of the first RAT and the second RAT. In some other cases, the mapping function of the cellular modem 415 may use information of a PDU session 465-a corresponding to an aggregated set of multiple QoS flows of the first RAT to map the PDU session 465-a into a single service class flow. Additionally, or alternatively, the mapping function may implement to a QoS flow description mapping (e.g., a GBR, a modified bit rate (MBR), an average window, 5QI parameters, or any combination thereof) between the first RAT and the second RAT. The flow descriptions for each QoS flow may include examples of parameter values for a set of QoS parameters for a QoS flow. For example, a QoS flow may be associated with a value for each of a GBR, MBR, average window, and a set of 5QI parameters.

The mapping function may also correspond to application of QoS translation rules (e.g., an IP packet filter set). In some examples, the cellular modem 415 may provide a mapping from a VLAN tag to a PDU session by mapping an uplink VLAN tagged ethernet frame to an associated IP PDU session. In some cases, the uplink VLAN tag may be removed after performing the mapping. In some cases, a separate IP PDU session may be implemented for end devices which connect to the ethernet NIC 450-a (e.g., included in the Wi-Fi router 410). In such cases, the mapping function may not map the ethernet NIC 450-a to a QoS flow. The QoS flows may mapped such as to be communicated via the PDU sessions 645 or PDU session 470 to communicate via the UPF 475.

In the case of the FWA CPE 405 operating according to an IP PDU session based architecture, the mapping communicator 425 may be an example of a DHCP server. Alternatively, in the case of the FWA CPE 405 operating according to an ethernet PDU session based architecture, the mapping communicator 425 may be an example of a DHCP server or an HTTP server.

In case of using DHCP to communicate mapping information, such as when the cellular modem 415 and the Wi-Fi router 410 are in separate physical boxes and connected via ethernet cable, the mapping communicator 425 of the cellular modem 415 (e.g., the first network device) may be an example of a DHCP server, and the mapping communicator 420 of the Wi-Fi router 410 may be an example of a DHCP client. The DHCP server may transmit a DHCP OFFER message to the DHCP client. The DHCP OFFER message may include an identifier, such as a field code (e.g., field code 43), that may cause the DHCP OFFER message to be retained (e.g., not discarded) by the DHCP client. That is, in some examples, the DHCP OFFER message is transmitted in response to a DHCP request by the client. However, use of a field code known by the DHCP client may cause the client to retain the message. The DHCP OFFER message may include the QoS mapping information such as to provide the information to the Wi-Fi router 410.

In other cases, the CPE 405 is a one box CPE such that the Wi-Fi router 410 and the cellular modem 415 are integrated into a single physical device. In such cases, the Wi-Fi router 410 and the cellular modem 415 may be configured to communicate via a software stack, via a serial communication, or a combination thereof.

As described herein, the router 410 may support VLAN mapping for end-to-end QoS establishment. In some cases, the VLAN mapping may be performed based on a user preferred DNN selection or dynamically. In either case, the router 410 may be configured with a DNN type (e.g., service type) to VLAN mapping table (with a default DNN). The DNN type to VLAN type mapping table may be an example of mapping information that is communicated to the router 410 via the modem 415. For example, the router 410 (e.g., the Wi-Fi AP) may be configured with a list of supported DNN types, such as augmented reality, virtual reality, internet, TV. More particularly, the router 410 may be configured with a DNN type to VLAN tag mapping table that includes a default DNN. The user may log into (or connect to) the Wi-Fi AP, select a DNN type from the configured list (e.g., select or open an application associated with a DNN) via a STA, which may be identified by a medium access control (MAC) address. In response to selecting a DNN type, the router 410 may associate a VLAN tag with the MAC address for the STA (e.g., a STA 480) according to the DNN type and the VLAN tag mapping table. the router 410 (e.g., VLAN handler) may receive an uplink packet, and insert the corresponding VLAN tag based on the MAC address and the mapping.

In some cases, the VLAN mapping may be performed dynamically by the router 410. For example, the router 410 (e.g., the Wi-Fi AP) may be configured with a list of supported DNN types, such as augmented reality, virtual reality, internet, TV. More particularly, the router 410 may be configured with a DNN type to VLAN tag mapping table that includes a default DNN. The router 410 may receive an uplink packet from a STA 480, and the router (e.g., the VLAN handler 445-a) may associate a default VLAN tag with the STA MAC address according to the DNN type to VLAN tag mapping table. The router 410 may then perform VLAN mapping dynamic learning with stream classification service (SCI), deep packet inspection (DPI), and/or machine learning. The deep packet inspection and mapping can be based on destination IP address, source/destination port number (e.g., port number range), and/or a domain name via a DNS monitor. The router 410 may determine new mapping of VLAN tags for the STA, and the VLAN tags can be mapped per STA or per application executing on a STA.

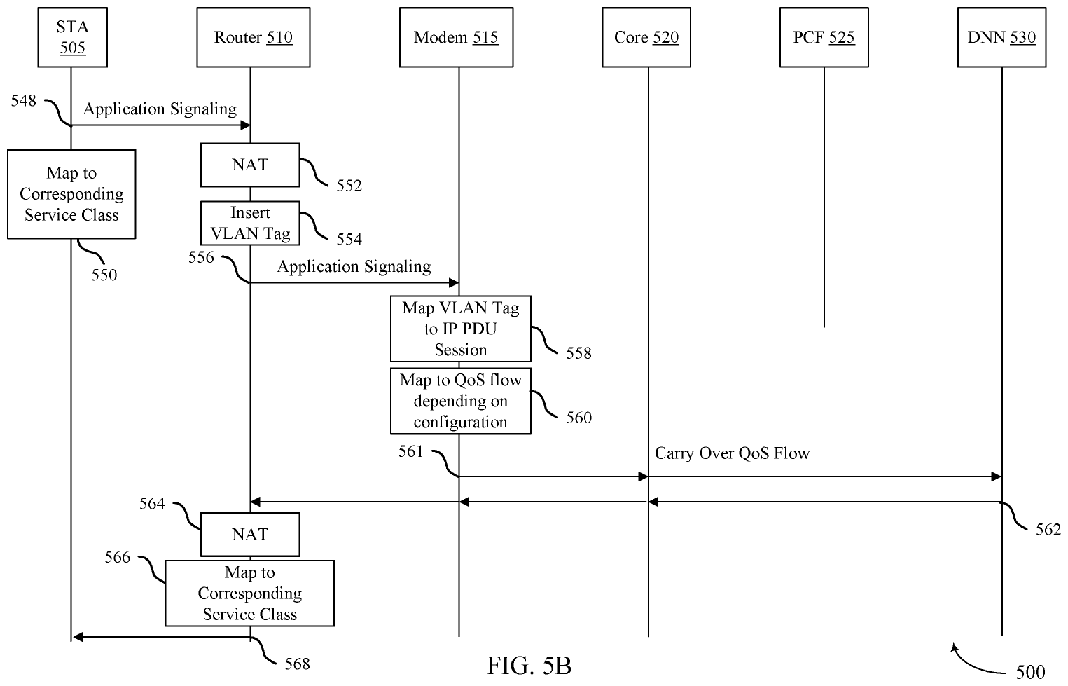

FIG. 5A and FIG. 5B illustrate an example of a process flow 500 that supports end-to-end QoS via a CPE in accordance with one or more aspects of the present disclosure. The process flow 500 includes a STA 505, a router 510, a modem 515 (e.g., a UE), a core network 520, a PCF 525, and a data network name (DNN) 530, which may be examples of the corresponding devices as described with respect to FIGS. 1 through 4. The router 510 may be an example of a Wi-Fi router and may include functionality of an AP and for NAT. In some examples, the router 510 and the modem 515 are a part of a CPE. The router 510 and the modem 515 may be housed in the same box as the CPE or in different boxes but configured to function as the CPE. The router 510 may be configured to support a set of service classes with corresponding QoS characteristics and VLAN tag mapping (per STA or per STA application). The modem 515 may be configured with information for QoS flow (e.g., 5QI) to service class mapping, such as a 5QI to service class mapping table, and a VLN tag to IP PDU session mapping table. The PCF 525 may be configured with PCC rules configuration for a CPE with known destination IP/port numbers (e.g., a range) or UE local port numbers or port number ranges after NAT.

The process flow 500 illustrates example operations for a static PCC rules based end-to-end QoS establishment. For implementing static PCC rules (e.g., translation rules), the IP addresses/port numbers, reserved UE local port numbers, or local port number ranges (after NAT) are configured at the PCF for the packet filter configuration. Additionally, with static PCC rules, both non-GBR and GBR QoS flows may be established before a STA initiates application communication. In the following description of the process flow 500, the operations between the devices may be transmitted in a different order than the example order shown, or the operations performed may be performed in different orders or at different times. Some operations may also be omitted from the process flow 500, and other operations may be added to the process flow 500.

At 531, the CPE including the modem 515 and the router 510 is powered on. In response to powering on, at 532, the modem 515 and the PCF 525 may communicate (e.g., via the core network 520) to perform cellular registration (e.g., 5GS Registration). After cellular registration, at 534, the modem 515 may transmit a PDU establishment request to the core network 520. In response, the PCF 525 may transmit a PDU establishment accept message, at 535, and may communicate, at 536, a set of QoS parameter values per QoS flow of a plurality of QoS flows. For example, the PCF 525 may communicate, to the modem 515, QoS flow descriptions, QoS rules, IP packet filter sets, etc. The flow descriptions may indicate whether each QoS flow is GBR QoS or non-GBR QoS and may include information such as a maximum flow bit rate (MFBR) per QoS flow, a GBR per QoS flow, an averaging window per QoS flow, the QoS identifier (5QI) per QoS flow, or a combination thereof. The QoS parameter values may be communicated via control signaling.

At 538, the modem 515 map each QoS flow of the plurality of QoS flows to one or more service classes of the plurality of service classes based at least in part on the set of QoS parameter values for the plurality of QoS flows. The mapping may be further based on QoS identifiers of the plurality of QoS flows and a mapping table including the plurality of service classes, description information associated with each QoS flow, the packet filter information, or a combination thereof. In some examples, the QoS mapping may aggregate one or more QoS identifiers (e.g., 5QIs) into a service class based on a mapping table, map flow descriptions to service class flow descriptions, and QoS flow rules to service class rules. Mapping flow descriptions may include mapping parameter values of the first RAT (e.g., cellular QoS flow parameter values) to parameter values of the second RAT (e.g., Wi-Fi service class parameter values). Rules mapping may include mapping network addresses (e.g., public IP addresses to private IP addresses). In some examples, mapping may include aggregation of one or more service classes to a QoS flow. Operations at 535 through 538 may be repeated for each PDU session. Information of the mapping table associated with the service classes (e.g., service class descriptions, parameter values, etc.) may be communicated by the router 510 to the modem 515.

At 540, the modem 515 may transmit, and the router 510 may receive, mapping information indicating a mapping of each QoS flow of a plurality of QoS flows of the first radio access technology (e.g., cellular) to one or more service classes of a plurality of service classes of a second radio access technology (e.g., Wi-Fi). The mapping information may be transmitted via an internal software stack of the CPE, via a serial communication, via HTTP, or via DHCP, as described herein. At 542, the router 510 may configure QoS translation rules based on the provided mapping information.

At 544, the router 510 may receive, from the STA 505, a service class request (e.g., a Wi-Fi QoS), and at 546, the router 510 may transmit a response to the STA 505.

In FIG. 5B, at 548, the STA 505 may transmit and the router 510 may receive application traffic. At 550, the STA 505 may map corresponding GBR or non-GBR service classes to application traffic depending on the QoS/service class information received from the router 510 (e.g., via the QoS response at 546).

At 552, the router 510 may perform NAT for packets of the application traffic. For example, the router 510 may receive the packet from the STA 505 (e.g., a device) via a first service class of the router 510. The router 510 may replace a first network address (e.g., a private IP address) of the header of the packet with a second network address (e.g., a public IP address) based on the mapping information received from the modem 515. At 554, the router 510 may insert, into one or more packets of the application traffic, a traffic identifier (e.g., a VLAN tag) into the header of the packet. The VLAN tag that is inserted may be based on the mapping information received from the modem 515 For example, the VLAN tag may correspond to a PDU session for the QoS flow that is mapped to the service class used to communicate the packet to the router 510 by the STA 505.

At 556, the translated packet (e.g., packet with translated network address and included network identifier) is communicated to the modem 515 as application signaling. At 558, the modem 515 may map the packet to a PDU session based on the VLAN tag inserted by the router 510. At 560, the modem 515 may map the packet to a QoS flow of the second RAT (e.g., cellular communications) depending on a network configuration. In some examples, the mapping of the packet may be based on the VLAN tag and the translated IP address. At 561, the application packet is transmitted via the core network 520 to the DNN 530 using the corresponding QoS flow.

At 562, one or more downlink packets are transmitted to the modem 515 via the core network 520 and a QoS flow. The modem 515 may communicate the packets to the router 510. At 564, the router 510 performs NAT for the one or more downlink packets. For example, the router may replace a first network address (e.g., a public IP address) in the header of a downlink packet with a second network address (e.g., a private IP address). At 566, the router 510 may map the one or more downlink packets to a service class (e.g., GBR or non-GBR) based on the QoS flow used to receive the one or more downlink packets and the mapping information received from the router 510. At 568, the one or more downlink packets are communicated to the STA 505 using the service class. In some examples, the router 510 may schedule the one or more downlink packets based on the service classes corresponding to each packet.

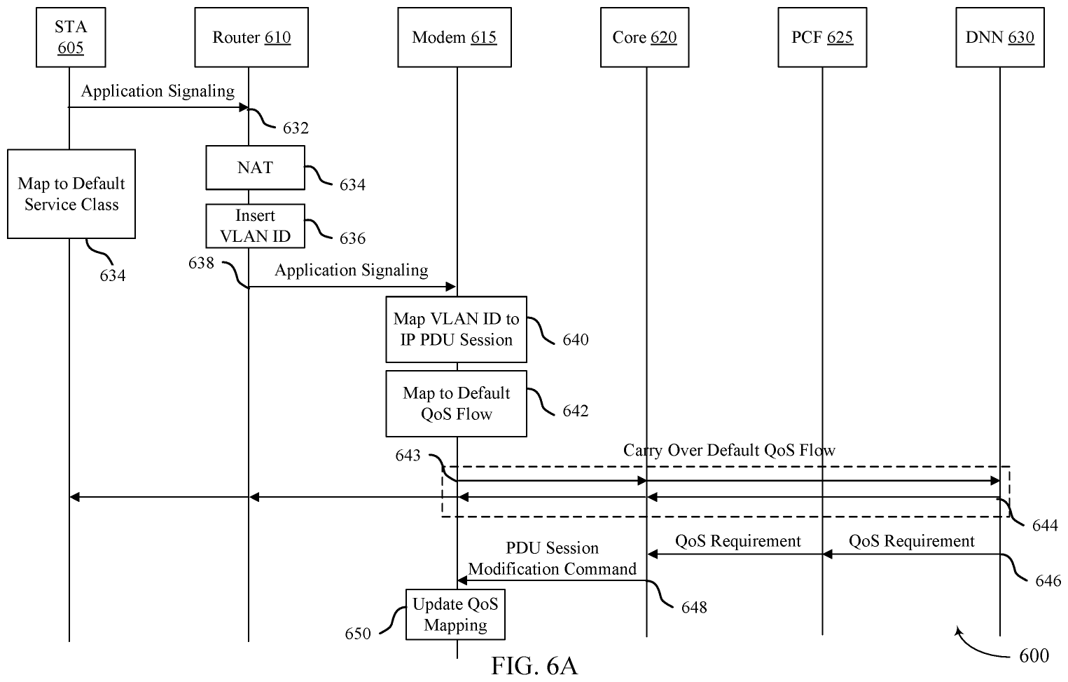

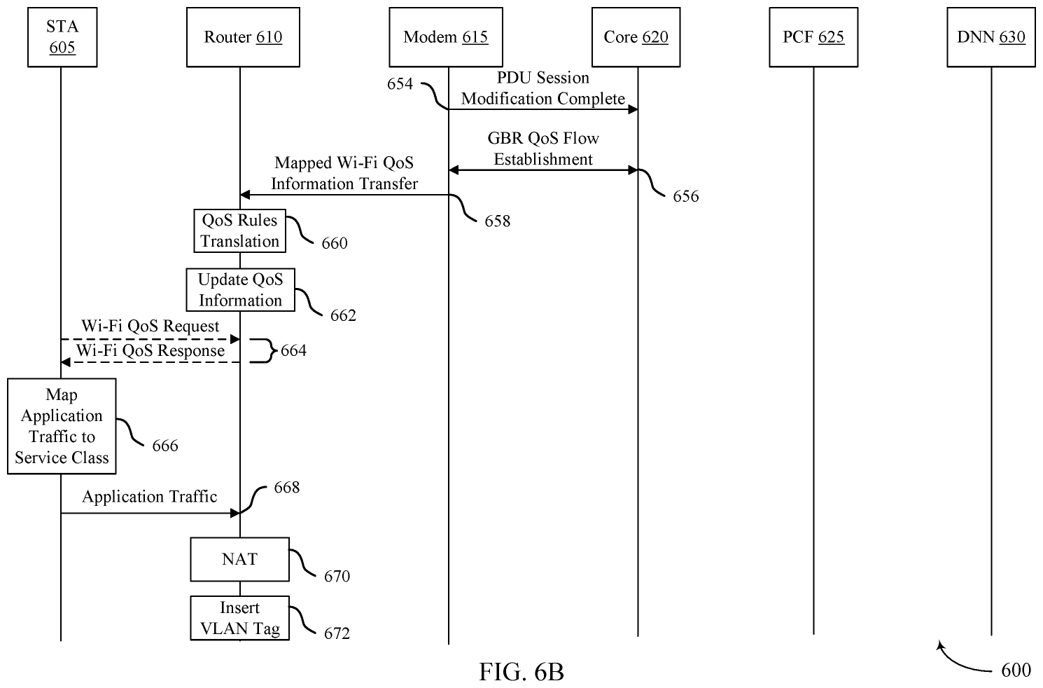

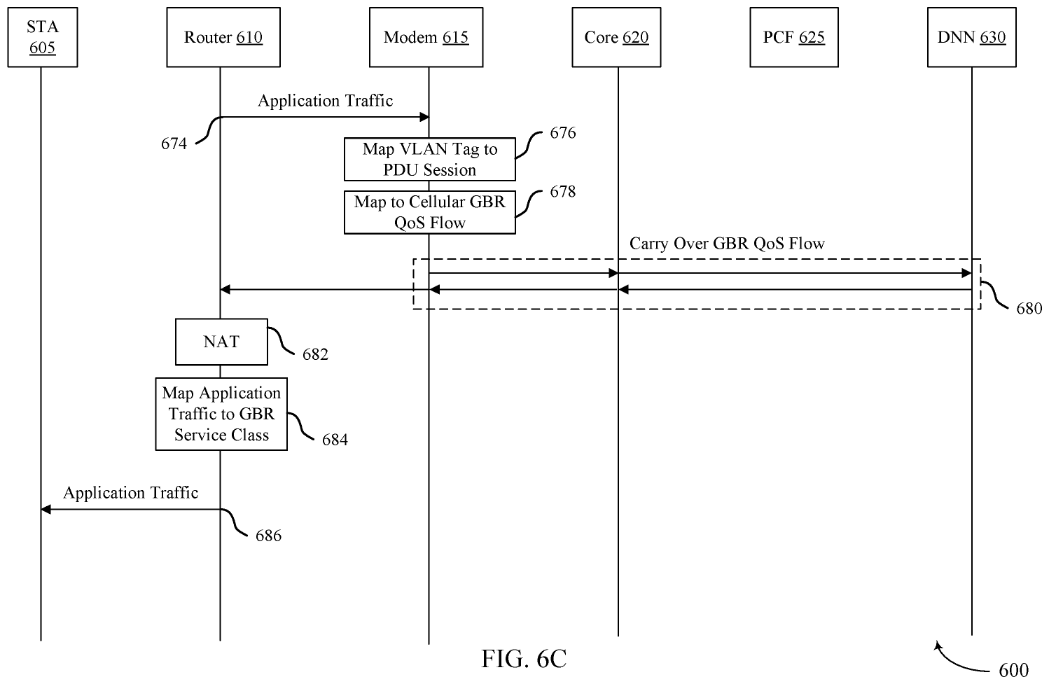

FIG. 6A, FIG. 6B, and FIG. 6C illustrate an example of a process flow 600 that supports end-to-end QoS via a CPE in accordance with one or more aspects of the present disclosure. The process flow 600 includes a STA 605, a router 610, a modem 615 (e.g., a UE), a core network 620, a PCF 625, and a DNN 630, which may be examples of the corresponding devices as described with respect to FIGS. 1 through 5. The router 610 may be an example of a Wi-Fi router and may include functionality of an AP and for NAT. In some examples, the router 610 and the modem 615 are a part of a CPE. The router 610 and the modem 615 may be housed in the same box as the CPE or in different boxes but configured to function as the CPE. The router 610 may be configured to support a set of service classes with corresponding QoS characteristics and VLAN tag mapping (per STA or per STA application).

The process flow 600 illustrates example operations for dynamic PCC rules-based end-to-end QoS establishment. When the CPE powers up, a default QoS (e.g., a non-GBR) QoS is established during PDU session establishment. Other QoS, such as GBR QoS is established after the STA 605 initiates the application layer signaling with an application function (e.g., the application server 350 of FIG. 3), which may trigger the PCF 625) to establish at least one dedicated QoS (e.g., a GBR QoS). In this example, there may be no pre-configured or known destination IP address or port numbers (e.g., or IP address/port number ranges), reserved UE local port number(s), and/or local port number ranges at the PCF 625 for packet filter configurations.

At 632, the STA 605 may transmit application signaling (e.g., one or more uplink packets) using a default QoS flow. That is, the one or more packets may be transmitted to the router 610 using a default service class. Based the dynamic QoS flows and service classes not being configured yet, the router 610 may perform NAT at 634 and insert network identifiers (e.g., VLAN tags) at 636 such as to correspond to the default QoS flow for the cellular network side. That is, the router 610 may translate network addresses (e.g., private IP to public IP address) of the packets and insert a VLAN tag into the header of the packet such that the packet is transmitted via the default QoS flow by the modem 615. At 638, the translated packet is transmitted to the modem 615 via application signaling.

At 640, the modem 615 maps the received uplink packets to the IP PDU session using the network identifiers (e.g., VLAN tags) inserted by the router 610. The modem 615 may remove the network identifiers because the tags are to be transmitted via the IP PDU session. At 642, the modem 615 may map the one or uplink packets to the default QoS flow, and at 643, the modem 615 may transmit the uplink packets via the core network 620 to the DNN 630 via the default QoS flow. At 644, the DNN 630 may transmit downlink packets to the STA 605 via the default QoS flow.

In response to receiving the uplink packets via the default QoS flow, the application function of the DNN 630 may request a dedicated QoS requirement from the cellular system. The application function may provide the STA 605 application source and destination IP address/port numbers to the PCF 625 for the dedicated QoS flow (e.g., dedicated GBR QoS flow). That is, at 646, the DNN 630 may transmit the QoS requirements to the PCF 625, and the requirements may include the indications of the IP addresses/port numbers. The PCF 625 relay these requirements to the core network 620, which may trigger a PDU session modification command at 648 to the modem 615, and the PDU session modification command may include parameters for the QoS flows that are to be established and mapped to the service classes. For example, the PDU session modification command may include QoS flow descriptions (e.g., GBR, MFBR, average window, QoS identifiers).

At 650, the modem 615 may update the QoS mapping. That, the modem 615 may map the new QoS flow(s) to one or more service classes based on the QoS parameters received via the PDU session modification command. The mapping may include aggregating one or more 5Qis into one or more Wi-Fi service classes, mapping QoS flow descriptions Wi-Fi service class descriptions (e.g., mapping to service class identifiers), and QoS rules to service class mapping. Information of the mapping table associated with the service classes (e.g., service class descriptions, parameter values, etc.) may be communicated by the router 610 to the modem 615.

At 654 of FIG. 6B, the modem 615 may indicate, to the core network 620, that the PDU session modification is complete, and as such, at 656, the new (e.g., GBR) QoS flow is established. At 658, the modem 615 may transmit, to the router 610, mapping information that indicates each QoS flow of a plurality of QoS flows of a first radio access technology (e.g., cellular) to one or more service classes of a plurality of service classes of a second radio access technology (e.g., Wi-Fi) supported by the first network device (e.g., the router 610).

At 660, the router 610 may initiate QoS rules translation procedures, and at 662, the router 610 may update QoS information. At 664, the STA 605 may transmit a service class request, and the router 610 may transit a service class QoS response. In response, at 666, the application traffic of the STA 605 is mapped to the service class. At 668, the application traffic (e.g., one or more uplink packets) is transmitted to the router via the service class. At 670, the router 610 may perform NAT for the application traffic. That is, the router 610 may translate network addresses (e.g., private IP addresses to public IP address translation) for the packets. At 672, the router 610 may transmit insert traffic identifiers (e.g., VLAN tags) into the packets based on the mapping information. More particularly, the router 610 may insert VLAN tags that correspond to the new PDU session of the new QoS flow.

At 674 of FIG. 6C, the router 610 may transmit, to the modem 615, the application traffic (e.g., the uplink packets). At 676, the modem 615 may map the traffic identifier (e.g., the VLAN tag) to the PDU session corresponding to the QoS flow. At 678, the modem 615 may map the application traffic to the cellular QoS flow (e.g., the GBR QoS flow). At 680, the uplink traffic is communicated via the dynamically established QoS flow and downlink application traffic may be received via the dynamically established QoS flow. The downlink traffic may be communicated to the router 610 based on the packet filters and mapping information. At 682, the router 610 performs NAT (e.g., translation of IP addresses) for the downlink traffic, and at 684, the router 610 may map the application traffic to the corresponding service class (e.g., Wi-Fi service class). At 686, the application traffic is communicated to the STA 605 via the service class.

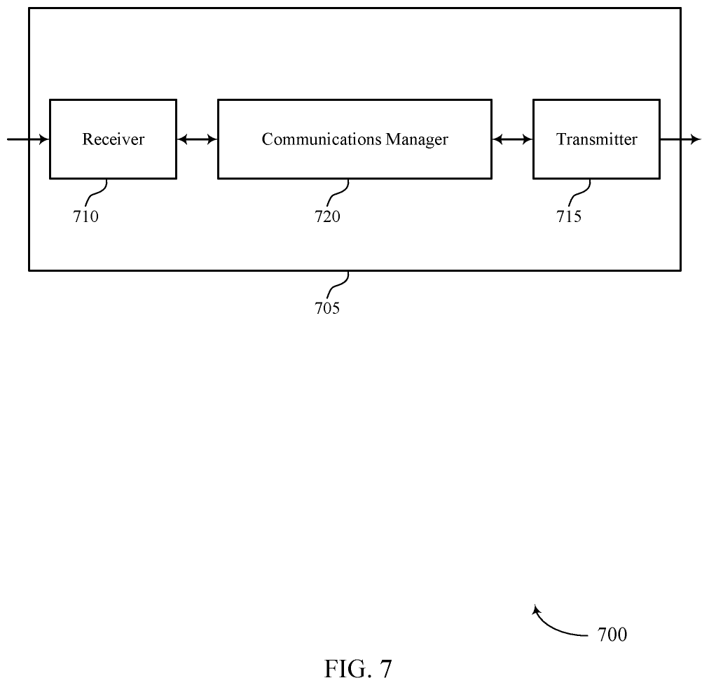

FIG. 7 illustrates a block diagram 700 of a device 705 that supports end-to-end QoS via a CPE in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to end-to-end QoS via a CPE). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to end-to-end QoS via a CPE). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of end-to-end QoS via a CPE as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

Additionally, or alternatively, the communications manager 720 may support wireless communication at a first network device in accordance with examples as disclosed herein. For example, the communications manager 720 may be configured as or otherwise support a means for transmitting, to a second network device, mapping information indicating a mapping of each QoS flow of a set of multiple QoS flows of a first radio access technology to one or more service classes of a set of multiple service classes of a second radio access technology, where the mapping is based on a set of QoS parameter values for the set of multiple QoS flows. The communications manager 720 may be configured as or otherwise support a means for communicating, based at least in part on the mapping information, a packet between a first QoS flow of the set of multiple QoS flows and a first service class of the set of multiple service classes.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources. Using the techniques and procedures described herein, end-to-end QoS may be established between a first RAT (e.g., cellular network) and a second RAT (e.g., Wi-Fi) such as to provide efficient and reliable communications via a CPE.

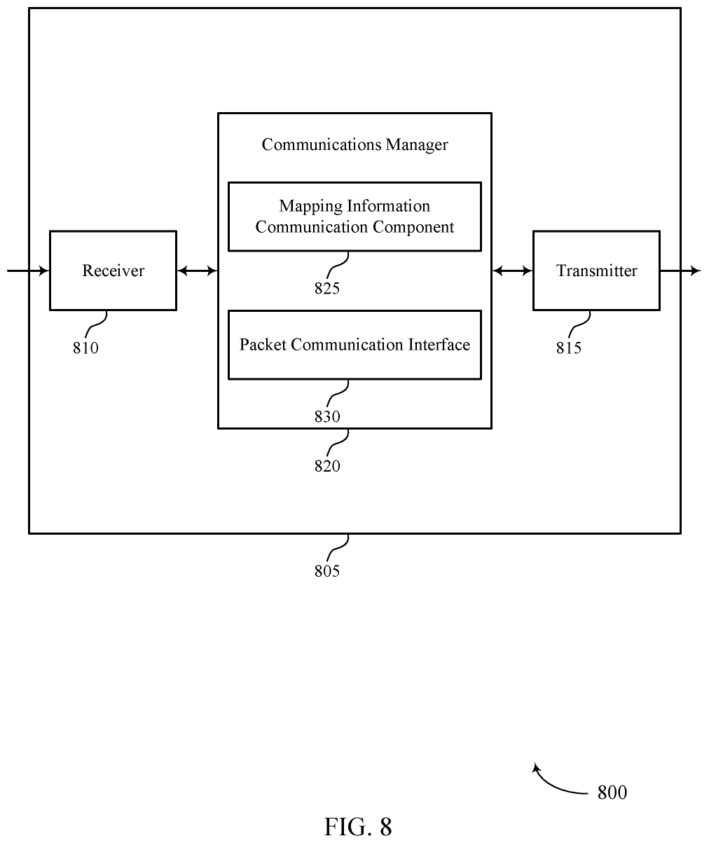

FIG. 8 illustrates a block diagram 800 of a device 805 that supports end-to-end QoS via a CPE in accordance with one or more aspects of the present disclosure. The device 805 may be an example of aspects of a device 905 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to end-to-end QoS via a CPE). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to end-to-end QoS via a CPE). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of end-to-end QoS via a CPE as described herein. For example, the communications manager 820 may include a mapping information communication component 825 a packet communication interface 830, or any combination thereof. The communications manager 820 may be an example of aspects of a communications manager 920 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first network device in accordance with examples as disclosed herein. The mapping information communication component 825 may be configured as or otherwise support a means for transmitting, to a second network device, mapping information indicating a mapping of each QoS flow of a set of multiple QoS flows of a first radio access technology to one or more service classes of a set of multiple service classes of a second radio access technology, where the mapping is based on a set of QoS parameter values for the set of multiple QoS flows. The packet communication interface 830 may be configured as or otherwise support a means for communicating, based on the mapping information, a packet between a first QoS flow of the set of multiple QoS flows and a first service class of the set of multiple service classes.

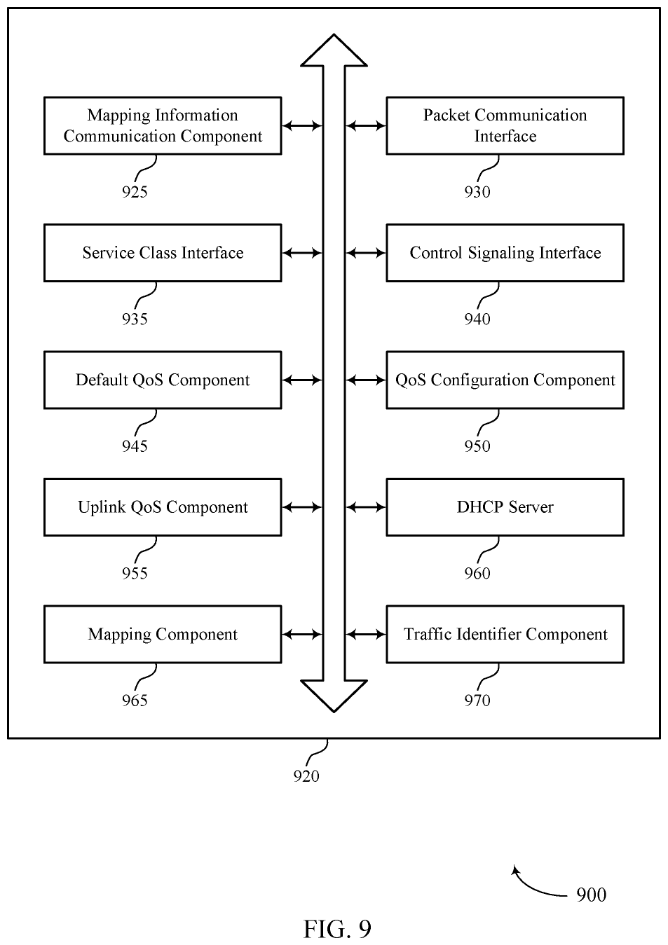

FIG. 9 illustrates a block diagram 900 of a communications manager 920 that supports end-to-end QoS via a CPE in accordance with one or more aspects of the present disclosure. The communications manager 920 may be an example of aspects of a communications manager 920, a communications manager 1020, or both, as described herein. The communications manager 920, or various components thereof, may be an example of means for performing various aspects of end-to-end QoS via a CPE as described herein. For example, the communications manager 920 may include a mapping information communication component 925, a packet communication interface 930, a service class interface 935, a control signaling interface 940, a default QoS component 945, a QoS configuration component 950, an uplink QoS component 955, a DHCP server 960, a mapping component 965, a traffic identifier component 970, or any combination thereof. Each of these components may communicate, directly or indirectly, with one another (e.g., via one or more buses).

Additionally, or alternatively, the communications manager 920 may support wireless communication at a first network device in accordance with examples as disclosed herein. The mapping information communication component 925 may be configured as or otherwise support a means for transmitting, to a second network device, mapping information indicating a mapping of each QoS flow of a set of multiple QoS flows of a first radio access technology to one or more service classes of a set of multiple service classes of a second radio access technology, where the mapping is based on a set of QoS parameter values for the set of multiple QoS flows. The packet communication interface 930 may be configured as or otherwise support a means for communicating, based on the mapping information, a packet between a first QoS flow of the set of multiple QoS flows and a first service class of the set of multiple service classes.

In some examples, the service class interface 935 may be configured as or otherwise support a means for receiving, from the second network device, an indication of the set of multiple service classes of the second radio access technology. In some examples, the service class interface 935 may be configured as or otherwise support a means for where each QoS flow is mapped to the one or more service classes based on receiving the indication of the set of multiple service classes.

In some examples, the control signaling interface 940 may be configured as or otherwise support a means for receiving, via the first radio access technology, control signaling indicating the set of QoS parameter values per QoS flow of the set of multiple QoS flows.

In some examples, the control signaling includes a set of internet protocol addresses that are to be communicated via a QoS flow of the set of multiple QoS flows. In some examples, the QoS flow is mapped to at least one of the set of multiple service classes based on the set of internet protocol addresses.

In some examples, the set of internet protocol addresses are received from a policy control function associated with the first radio access technology.

In some examples, the mapping information includes an indication of the set of internet protocol addresses that are to be communicated via the QoS flow.

In some examples, the service class interface 935 may be configured as or otherwise support a means for receiving, from the second network device, an indication of the set of multiple service classes of the second radio access technology. In some examples, the default QoS component 945 may be configured as or otherwise support a means for transmitting, based on receiving the indication of the set of multiple service classes and using a default QoS flow, uplink control signaling requesting the set of multiple QoS flows. In some examples, the QoS configuration component 950 may be configured as or otherwise support a means for receiving, via the first radio access technology based on transmitting the uplink control signaling, control signaling indicating the set of QoS parameter values per QoS flow of the set of multiple QoS flows.

In some examples, the uplink control signaling is transmitted to a policy control function associated with the first radio access technology.

In some examples, to support communicating the packet, the packet communication interface 930 may be configured as or otherwise support a means for receiving, from the second network device, the packet including a traffic identifier. In some examples, to support communicating the packet, the uplink QoS component 955 may be configured as or otherwise support a means for transmitting the packet via the first QoS flow based on the traffic identifier that is mapped to the first QoS flow.

In some examples, the traffic identifier component 970 may be configured as or otherwise support a means for removing the traffic identifier from the packet before transmitting the packet via the first QoS flow based on the traffic identifier corresponding to an internet protocol based QoS flow.

In some examples, the packet including the traffic identifier is transmitted via the first QoS flow based on the first QoS flow being an Ethernet based QoS flow.

In some examples, the traffic identifier is a virtual local area network tag.

In some examples, the mapping information is transmitted via a dynamic host configuration protocol message, a serial communication, or a HTTP.

In some examples, the mapping information is transmitted by a dynamic host configuration protocol (DHCP) server at the first network device and via a DHCP offer message that is transmitted to a DHCP client at the second network device. In some examples, the DHCP offer message includes the mapping information and indicates an identifier configured to cause the DHCP client to refrain from discarding the DHCP offer message.

In some examples, the mapping component 965 may be configured as or otherwise support a means for refraining from mapping an ethernet port of the second network device to a QoS flow.

In some examples, the second network device and the first network device are included in a CPE.

In some examples, the set of QoS parameter values per QoS flow include a delay budget value, a packet error rate value, a priority value, a bit rate value, a data burst volume value, a reflective QoS attribute value, periodicity value, or a combination thereof. In some examples, each service class of the set of multiple service classes is associated with a delay bound value, a packet loss ratio value, a priority value, a minimum throughput value, a maximum throughput value, a burst size value, a priority value, a service interval value, or a combination thereof.

In some examples, the mapping component 965 may be configured as or otherwise support a means for mapping each QoS flow of the set of multiple QoS flows to one or more service classes of the set of multiple service classes based on a QoS identifier of the set of multiple QoS flows and a mapping table including the set of multiple service classes, description information associated with each QoS flow, and packet filter information.

In some examples, to support transmitting the mapping information, the mapping information communication component 925 may be configured as or otherwise support a means for transmitting an indication of one or more QoS identifiers that are mapped to a service class of the set of multiple service classes, description information associated with each QoS flow, a packet filter set per QoS flow, or any combination thereof.

In some examples, to support transmitting the mapping information, the mapping information communication component 925 may be configured as or otherwise support a means for transmitting description information that indicates a maximum flow bit rate per QoS flow, a guaranteed flow bit rate per QoS flow, an averaging window per QoS flow, the QoS identifier per QoS flow, or a combination thereof.

In some examples, the first radio access technology is cellular communication technology and the second radio access technology is Wi-Fi.

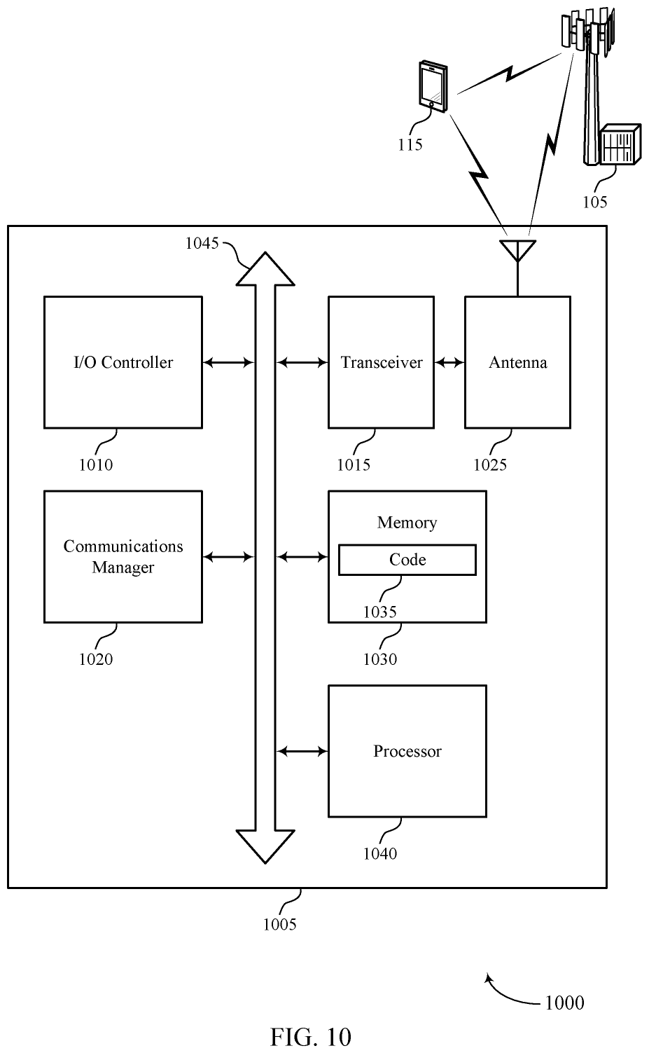

FIG. 10 illustrates a diagram of a system 1000 including a device 1005 that supports end-to-end QoS via a CPE in accordance with one or more aspects of the present disclosure. The device 1005 may be an example of or include the components of a device 905, a device 1005, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting end-to-end QoS via a CPE). For example, the device 1005 or a component of the device 1005 may include a processor 1040 and memory 1030 coupled with or to the processor 1040, the processor 1040 and memory 1030 configured to perform various functions described herein.

Additionally, or alternatively, the communications manager 1020 may support wireless communication at a first network device in accordance with examples as disclosed herein. For example, the communications manager 1020 may be configured as or otherwise support a means for transmitting, to a second network device, mapping information indicating a mapping of each QoS flow of a set of multiple QoS flows of a first radio access technology to one or more service classes of a set of multiple service classes of a second radio access technology, where the mapping is based on a set of QoS parameter values for the set of multiple QoS flows. The communications manager 1020 may be configured as or otherwise support a means for communicating, based at least in part on the mapping information, a packet between a first QoS flow of the set of multiple QoS flows and a first service class of the set of multiple service classes.

By including or configuring the communications manager 1020 in accordance with examples as described herein, the device 1005 may support techniques for improved communication reliability. Using the techniques and procedures described herein, end-to-end QoS may be established between a first RAT (e.g., cellular network) and a second RAT (e.g., Wi-Fi) such as to provide efficient and reliable communications via a CPE, which may enhance user experience at a STA.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of end-to-end QoS via a CPE as described herein, or the processor 1040 and the memory 1030 may be otherwise configured to perform or support such operations.

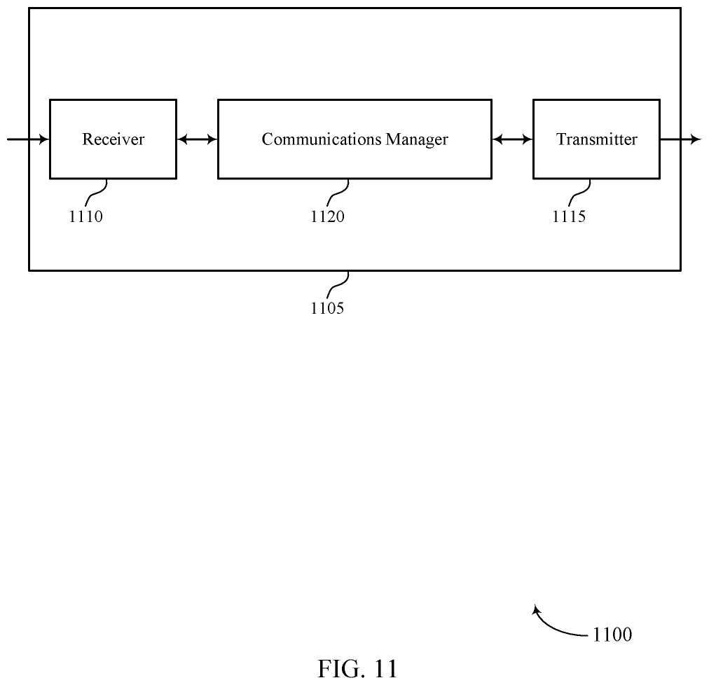

FIG. 11 illustrates a block diagram 1100 of a device 1105 that supports end-to-end QoS via a CPE in accordance with one or more aspects of the present disclosure. The device 1105 may be an example of aspects of an AP as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to end-to-end QoS via a CPE). Information may be passed on to other components of the device 1105. The receiver 1110 may utilize a single antenna or a set of multiple antennas.

The transmitter 1115 may provide a means for transmitting signals generated by other components of the device 1105. The transmitter 1115 may utilize a single antenna or a set of multiple antennas.

The communications manager 1120, the receiver 1110, the transmitter 1115, or various combinations thereof or various components thereof may be examples of means for performing various aspects of end-to-end QoS via a CPE as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

Additionally, or alternatively, the communications manager 1120 may support wireless communication at first network device in accordance with examples as disclosed herein. For example, the communications manager 1120 may be configured as or otherwise support a means for receiving, from a second network device, mapping information indicating a mapping of each QoS flow of a set of multiple QoS flows of a first radio access technology to one or more service classes of a set of multiple service classes of a second radio access technology supported by the first network device. The communications manager 1120 may be configured as or otherwise support a means for translating, using a translation rule included in the mapping information, a header of a packet between a first network address of the first radio access technology and a second network address used by the first network device. The communications manager 1120 may be configured as or otherwise support a means for communicating the packet between a device associated with the first network device using a first service class of the set of multiple service classes and a first QoS flow of the set of multiple QoS flows based on translation of the header.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources. Using the techniques and procedures described herein, end-to-end QoS may be established between a first RAT (e.g., cellular network) and a second RAT (e.g., Wi-Fi) such as to provide efficient and reliable communications via a CPE.

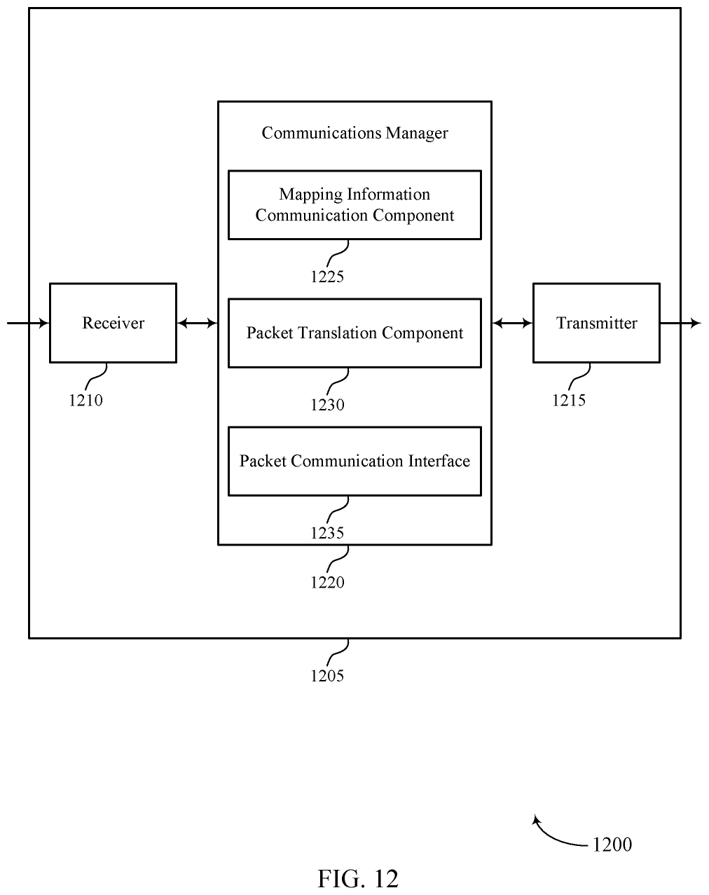

FIG. 12 illustrates a block diagram 1200 of a device 1205 that supports end-to-end QoS via a CPE in accordance with one or more aspects of the present disclosure. The device 1205 may be an example of aspects of a device 1305 or an AP as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to end-to-end QoS via a CPE). Information may be passed on to other components of the device 1205. The receiver 1210 may utilize a single antenna or a set of multiple antennas.

The transmitter 1215 may provide a means for transmitting signals generated by other components of the device 1205. The transmitter 1215 may utilize a single antenna or a set of multiple antennas.

The device 1205, or various components thereof, may be an example of means for performing various aspects of end-to-end QoS via a CPE as described herein. For example, the communications manager 1220 may include a mapping information communication component 1225, a packet translation component 1230, a packet communication interface 1235, or any combination thereof. The communications manager 1220 may be an example of aspects of a communications manager 1320 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at first network device in accordance with examples as disclosed herein. The mapping information communication component 1225 may be configured as or otherwise support a means for receiving, from a second network device, mapping information indicating a mapping of each QoS flow of a set of multiple QoS flows of a first radio access technology to one or more service classes of a set of multiple service classes of a second radio access technology supported by the first network device. The packet translation component 1230 may be configured as or otherwise support a means for translating, using a translation rule included in the mapping information, a header of a packet between a first network address of the first radio access technology and a second network address used by the first network device. The packet communication interface 1235 may be configured as or otherwise support a means for communicating the packet between a device associated with the first network device using a first service class of the set of multiple service classes and a first QoS flow of the set of multiple QoS flows based on translation of the header.

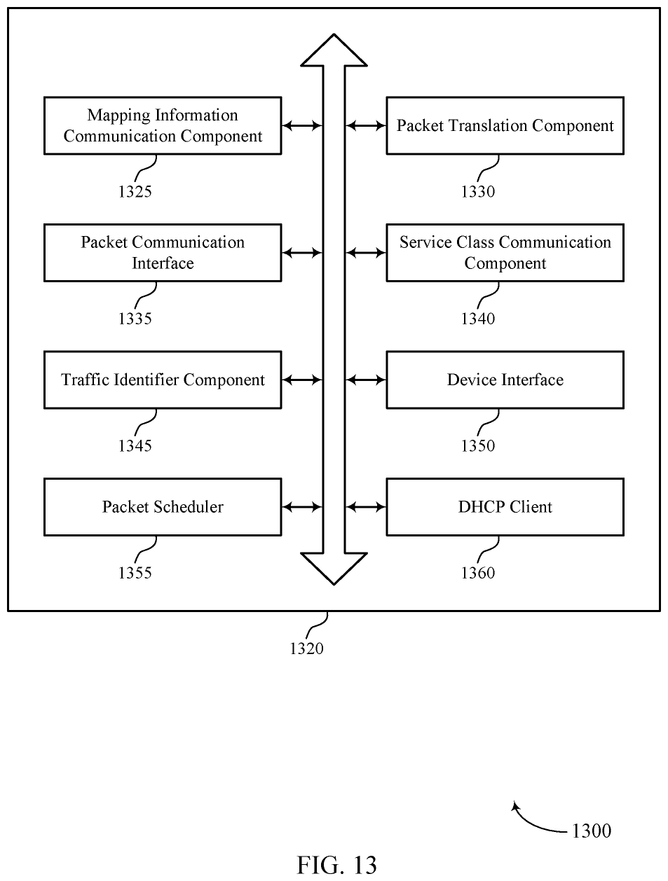

FIG. 13 illustrates a block diagram 1300 of a communications manager 1320 that supports end-to-end QoS via a CPE in accordance with one or more aspects of the present disclosure. The communications manager 1320 may be an example of aspects of a communications manager 1320, a communications manager 1420, or both, as described herein. The communications manager 1320, or various components thereof, may be an example of means for performing various aspects of end-to-end QoS via a CPE as described herein. For example, the communications manager 1320 may include a mapping information communication component 1325, a packet translation component 1330, a packet communication interface 1335, a service class communication component 1340, a traffic identifier component 1345, a device interface 1350, a packet scheduler 1355, a DHCP client 1360, or any combination thereof. Each of these components may communicate, directly or indirectly, with one another (e.g., via one or more buses).

Additionally, or alternatively, the communications manager 1320 may support wireless communication at first network device in accordance with examples as disclosed herein. The mapping information communication component 1325 may be configured as or otherwise support a means for receiving, from a second network device, mapping information indicating a mapping of each QoS flow of a set of multiple QoS flows of a first radio access technology to one or more service classes of a set of multiple service classes of a second radio access technology supported by the first network device. The packet translation component 1330 may be configured as or otherwise support a means for translating, using a translation rule included in the mapping information, a header of a packet between a first network address of the first radio access technology and a second network address used by the first network device. The packet communication interface 1335 may be configured as or otherwise support a means for communicating the packet between a device associated with the first network device using a first service class of the set of multiple service classes and a first QoS flow of the set of multiple QoS flows based on translation of the header.

In some examples, the mapping information includes an indication of a set of internet protocol addresses that are to be communicated to a QoS flow. In some examples, the header is translated based on the set of internet protocol addresses.

In some examples, the service class communication component 1340 may be configured as or otherwise support a means for transmitting, to the second network device, an indication of the set of multiple service classes. In some examples, the mapping information communication component 1325 may be configured as or otherwise support a means for where the mapping information is received based on transmitting the indication of the set of multiple service classes.

In some examples, the traffic identifier component 1345 may be configured as or otherwise support a means for transmitting, to the second network device, a second packet that includes a traffic identifier that is mapped to a default QoS flow associated with the first radio access technology. In some examples, the mapping information communication component 1325 may be configured as or otherwise support a means for where the mapping information is received based on transmitting the second packet.

In some examples, the device interface 1350 may be configured as or otherwise support a means for receiving from the device the second packet via a default service class. In some examples, the packet communication interface 1335 may be configured as or otherwise support a means for where the second packet is transmitted to the second network device based on receiving the second packet from the device.

In some examples, to support communicating the packet, the device interface 1350 may be configured as or otherwise support a means for receiving via the first service class, the packet from the device. In some examples, to support communicating the packet, the traffic identifier component 1345 may be configured as or otherwise support a means for inserting, into a header of the packet, a traffic identifier that corresponds to the first service class based on the mapping information. In some examples, to support communicating the packet, the packet communication interface 1335 may be configured as or otherwise support a means for transmitting, to the second network device, the packet that includes the traffic identifier.

In some examples, the traffic identifier is a virtual local area network tag.

In some examples, to support translating the header of the packet, the packet communication interface 1335 may be configured as or otherwise support a means for receiving the packet from the second network device, the packet including the first network address. In some examples, to support translating the header of the packet, the packet translation component 1330 may be configured as or otherwise support a means for replacing the first network address with the second network address that is mapped to the first network address via the mapping information. In some examples, to support translating the header of the packet, the packet communication interface 1335 may be configured as or otherwise support a means for where the packet is transmitted to the device via the first service class.

In some examples, to support translating the header of the packet, the device interface 1350 may be configured as or otherwise support a means for receiving, the packet from the device, the packet including the second network address. In some examples, to support translating the header of the packet, the packet translation component 1330 may be configured as or otherwise support a means for replacing the second network address with the first network address that is mapped to the second network address via the mapping information. In some examples, to support translating the header of the packet, the packet communication interface 1335 may be configured as or otherwise support a means for where the packet is transmitted to the second network device.

In some examples, the packet scheduler 1355 may be configured as or otherwise support a means for scheduling communication of a set of multiple packets including the packet based on a respective service class associated with each of the set of multiple packets. In some examples, the packet communication interface 1335 may be configured as or otherwise support a means for where the packet is communicated based on the scheduling.

In some examples, the mapping information is received via a dynamic host configuration protocol message, a serial communication, or a HTTP.

In some examples, the mapping information is received by a dynamic host configuration protocol (DHCP) client at the first network device and via a DHCP offer message that is transmitted by a DHCP server at the second network device. In some examples, the DHCP offer message includes the mapping information and indicates an identifier configured to cause the DHCP client to refrain from discarding the DHCP offer message.

In some examples, receiving the mapping information includes an indication of one or more QoS identifiers that are mapped to a service class of the set of multiple service classes, description information associated with each QoS flow, a packet filter set per QoS flow, or any combination thereof.

In some examples, receiving the mapping information includes receiving description information that indicates a maximum flow bit rate per QoS flow, a guaranteed flow bit rate per QoS flow, an averaging window per QoS flow, the QoS identifier per QoS flow, or a combination thereof.

In some examples, the mapping information does not include information associated with an ethernet port of the first network device.

In some examples, the first network device and the second network device are included in a CPE.

In some examples, the first radio access technology is fifth generation and the second radio access technology is Wi-Fi.

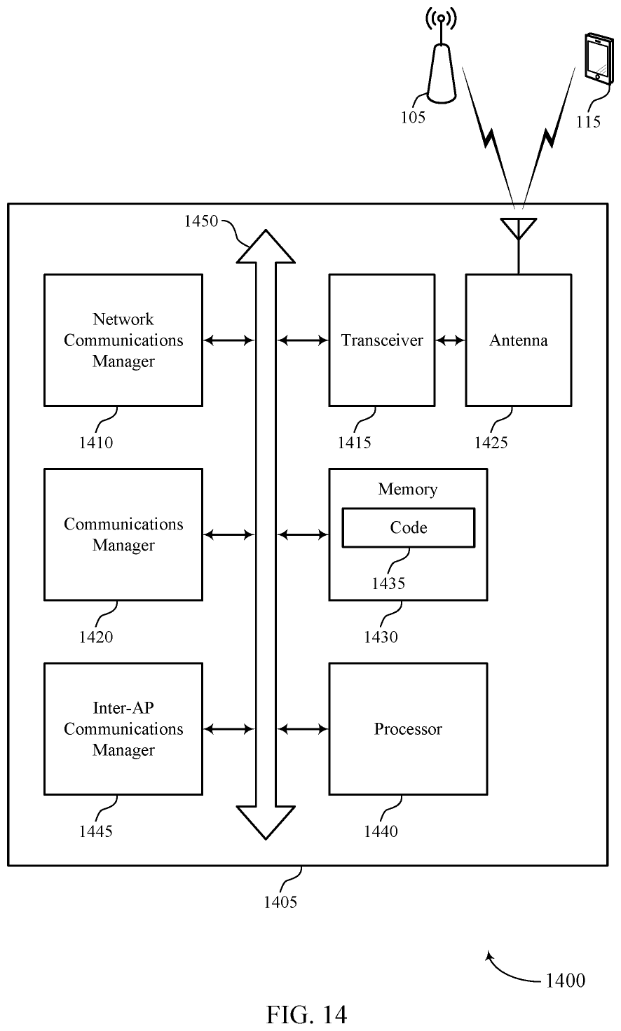

FIG. 14 illustrates a diagram of a system 1400 including a device 1405 that supports end-to-end QoS via a CPE in accordance with one or more aspects of the present disclosure. The device 1405 may be an example of or include the components of a device 1305, a device 1405, or an AP as described herein. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-AP communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network (e.g., via one or more wired backhaul links). For example, the network communications manager 1410 may manage the transfer of data communications for client devices, such as one or more STAs.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets and provide the modulated packets to one or more antennas 1425 for transmission, and to demodulate packets received from the one or more antennas 1425. The transceiver 1415, or the transceiver 1415 and one or more antennas 1425, may be an example of a transmitter 1315, a transmitter 1415, a receiver 1310, a receiver 1110, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. In some cases, the memory 1430 may contain, among other things, a BIOS which may control basic hardware or software operation such as the interaction with peripheral components or devices.

The processor 1440 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting end-to-end QoS via a CPE). For example, the device 1405 or a component of the device 1405 may include a processor 1440 and memory 1430 coupled with or to the processor 1440, the processor 1440 and memory 1430 configured to perform various functions described herein.

The inter-AP communications manager 1445 may manage communications with other APs, and may include a controller or scheduler for controlling communications with STAs in cooperation with other APs. For example, the inter-AP communications manager 1445 may coordinate scheduling for transmissions to APs for various interference mitigation techniques such as beamforming or joint transmission. In some examples, the inter-AP communications manager 1445 may provide an X2 interface within an LTE/LTE-A wireless communication network technology to provide communication between APs.

Additionally, or alternatively, the communications manager 1420 may support wireless communication at first network device in accordance with examples as disclosed herein. For example, the communications manager 1420 may be configured as or otherwise support a means for receiving, from a second network device, mapping information indicating a mapping of each QoS flow of a set of multiple QoS flows of a first radio access technology to one or more service classes of a set of multiple service classes of a second radio access technology supported by the first network device. The communications manager 1420 may be configured as or otherwise support a means for translating, using a translation rule included in the mapping information, a header of a packet between a first network address of the first radio access technology and a second network address used by the first network device. The communications manager 1420 may be configured as or otherwise support a means for communicating the packet between a device associated with the first network device using a first service class of the set of multiple service classes and a first QoS flow of the set of multiple QoS flows based on translation of the header.

By including or configuring the communications manager 1420 in accordance with examples as described herein, the device 1405 may support techniques for improved communication reliability. Using the techniques and procedures described herein, end-to-end QoS may be established between a first RAT (e.g., cellular network) and a second RAT (e.g., Wi-Fi) such as to provide efficient and reliable communications via a CPE, which may enhance user experience at a STA.

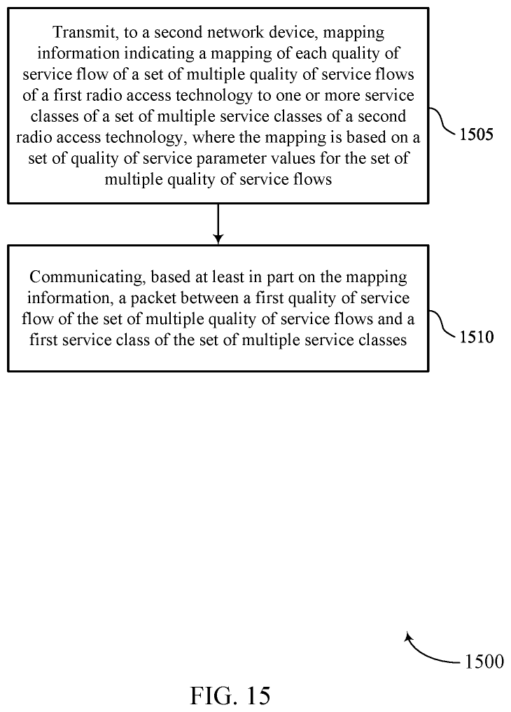

FIG. 15 illustrates a flowchart illustrating a method 1500 that supports end-to-end QoS via a CPE in accordance with one or more aspects of the present disclosure. The operations of the method 1500 may be implemented by a UE or its components as described herein. For example, the operations of the method 1500 may be performed by a UE 115 as described with reference to FIGS. 3 through 12. In some examples, a UE may execute a set of instructions to control the functional elements of the UE to perform the described functions. Additionally, or alternatively, the UE may perform aspects of the described functions using special-purpose hardware.

At 1505, the method may include transmitting, to a second network device, mapping information indicating a mapping of each QoS flow of a set of multiple QoS flows of a first radio access technology to one or more service classes of a set of multiple service classes of a second radio access technology, where the mapping is based on a set of QoS parameter values for the set of multiple QoS flows. The operations of 1505 may be performed in accordance with examples as disclosed herein. In some examples, aspects of the operations of 1505 may be performed by a mapping information communication component 1125 as described with reference to FIG. 11.

At 1510, the method may include communicating, based on the mapping information, a packet between a first QoS flow of the set of multiple QoS flows and a first service class of the set of multiple service classes. The operations of 1510 may be performed in accordance with examples as disclosed herein. In some examples, aspects of the operations of 1510 may be performed by a packet communication interface 1130 as described with reference to FIG. 11.

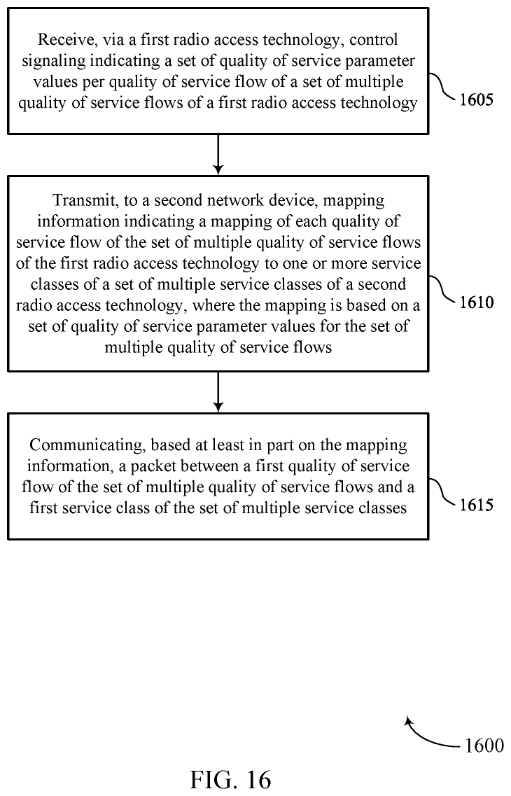

FIG. 16 illustrates a flowchart illustrating a method 1600 that supports end-to-end QoS via a CPE in accordance with one or more aspects of the present disclosure. The operations of the method 1600 may be implemented by a UE or its components as described herein. For example, the operations of the method 1600 may be performed by a UE 115 as described with reference to FIGS. 3 through 12. In some examples, a UE may execute a set of instructions to control the functional elements of the UE to perform the described functions. Additionally, or alternatively, the UE may perform aspects of the described functions using special-purpose hardware.

At 1605, the method may include receiving, via a first radio access technology, control signaling indicating a set of QoS parameter values per QoS flow of a set of multiple QoS flows. The operations of 1605 may be performed in accordance with examples as disclosed herein. In some examples, aspects of the operations of 1605 may be performed by a control signaling interface 1140 as described with reference to FIG. 11.

At 1610, the method may include transmitting, to a second network device, mapping information indicating a mapping of each QoS flow of a set of multiple QoS flows of a first radio access technology to one or more service classes of a set of multiple service classes of a second radio access technology, where the mapping is based on a set of QoS parameter values for the set of multiple QoS flows. The operations of 1610 may be performed in accordance with examples as disclosed herein. In some examples, aspects of the operations of 1610 may be performed by a mapping information communication component 1125 as described with reference to FIG. 11.

At 1615, the method may include communicating, based on the mapping information, a packet between a first QoS flow of the set of multiple QoS flows and a first service class of the set of multiple service classes. The operations of 1615 may be performed in accordance with examples as disclosed herein. In some examples, aspects of the operations of 1615 may be performed by a packet communication interface 1130 as described with reference to FIG. 11.

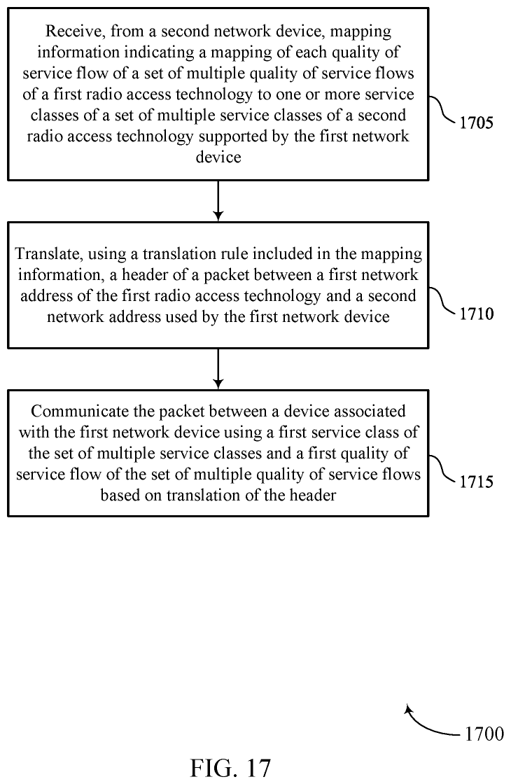

FIG. 17 illustrates a flowchart illustrating a method 1700 that supports end-to-end QoS via a CPE in accordance with one or more aspects of the present disclosure. The operations of the method 1700 may be implemented by an AP or its components as described herein. For example, the operations of the method 1700 may be performed by an AP as described with reference to FIGS. 1 through 6c. and 11 through 14. In some examples, an AP may execute a set of instructions to control the functional elements of the AP to perform the described functions. Additionally, or alternatively, the AP may perform aspects of the described functions using special-purpose hardware.

At 1705, the method may include receiving, from a second network device, mapping information indicating a mapping of each QoS flow of a set of multiple QoS flows of a first radio access technology to one or more service classes of a set of multiple service classes of a second radio access technology supported by the first network device. The operations of 1705 may be performed in accordance with examples as disclosed herein. In some examples, aspects of the operations of 1705 may be performed by a mapping information communication component 1525 as described with reference to FIG. 15.

At 1710, the method may include translating, using a translation rule included in the mapping information, a header of a packet between a first network address of the first radio access technology and a second network address used by the first network device. The operations of 1710 may be performed in accordance with examples as disclosed herein. In some examples, aspects of the operations of 1710 may be performed by a packet translation component 1530 as described with reference to FIG. 15.

At 1715, the method may include communicating the packet between a device associated with the first network device using a first service class of the set of multiple service classes and a first QoS flow of the set of multiple QoS flows based on translation of the header. The operations of 1715 may be performed in accordance with examples as disclosed herein. In some examples, aspects of the operations of 1715 may be performed by a packet communication interface 1535 as described with reference to FIG. 15.

The following provides an overview of aspects of the present disclosure:

Aspect 1: A method for wireless communication at a first network device, comprising: transmitting, to a second network device, mapping information indicating a mapping of each QoS flow of a plurality of QoS flows of a first RAT to one or more service classes of a plurality of service classes of a second RAT, wherein the mapping is based at least in part on a set of QoS parameter values for the plurality of QoS flows; and communicating, based at least in part on the mapping information, a packet between a first QoS flow of the plurality of QoS flows and a first service class of the plurality of service classes.

Aspect 2: The method of aspect 1, further comprising: receiving, from the second network device, an indication of the plurality of service classes of the second RAT; and wherein each QoS flow is mapped to the one or more service classes based at least in part on receiving the indication of the plurality of service classes.

Aspect 3: The method of any of aspects 1 through 2, further comprising: receiving, via the first RAT, control signaling indicating the set of QoS parameter values per QoS flow of the plurality of QoS flows.

Aspect 4: The method of aspect 3, wherein the control signaling comprises a set of internet protocol addresses that are to be communicated via a QoS flow of the plurality of QoS flows; and the QoS flow is mapped to at least one of the plurality of service classes based at least in part on the set of internet protocol addresses.

Aspect 5: The method of aspect 4, wherein the set of internet protocol addresses are received from a policy control function associated with the first RAT.

Aspect 6: The method of any of aspects 4 through 5, wherein the mapping information comprises an indication of the set of internet protocol addresses that are to be communicated via the QoS flow.

Aspect 7: The method of any of aspects 1 through 6, further comprising: receiving, from the second network device, an indication of the plurality of service classes of the second RAT; transmitting, based at least in part on the indication of the plurality of service classes and using a default QoS flow, uplink control signaling requesting the plurality of QoS flows; and receiving, via the first RAT based at least in part on the uplink control signaling, control signaling indicating the set of QoS parameter values per QoS flow of the plurality of QoS flows.

Aspect 8: The method of aspect 7, wherein the uplink control signaling is transmitted to a policy control function associated with the first RAT.

Aspect 9: The method of any of aspects 1 through 8, wherein communicating the packet comprises: receiving, from the second network device, the packet comprising a traffic identifier; and transmitting the packet via the first QoS flow based at least in part on the traffic identifier that is mapped to the first QoS flow.

Aspect 10: The method of aspect 9, further comprising: removing the traffic identifier from the packet before transmitting the packet via the first QoS flow based at least in part on the traffic identifier corresponding to an internet protocol based QoS flow.

Aspect 11: The method of any of aspects 9 through 10, wherein the packet comprising the traffic identifier is transmitted via the first QoS flow based at least in part on the first QoS flow being an Ethernet based QoS flow.

Aspect 12: The method of any of aspects 9 through 10, wherein the traffic identifier is a virtual local area network tag.

Aspect 13: The method of any of aspects 1 through 12, wherein the mapping information is transmitted via a dynamic host configuration protocol message, a serial communication, or an HTTP message.

Aspect 14: The method of any of aspects 1 through 12, wherein the mapping information is transmitted by a dynamic host configuration protocol (DHCP) server at the first network device and via a DHCP offer message that is transmitted to a DHCP client at the second network device; and the DHCP offer message includes the mapping information and indicates an identifier configured to cause the DHCP client to refrain from discarding the DHCP offer message.

Aspect 15: The method of any of aspects 1 through 14, further comprising: refraining from mapping an ethernet port of the second network device to a QoS flow.

Aspect 16: The method of any of aspects 1 through 15, wherein the second network device and the first network device are included in a customer premises equipment (CPE).

Aspect 17: The method of any of aspects 1 through 16, wherein the set of QoS parameter values per QoS flow comprise a delay budget value, a packet error rate value, a priority value, a bit rate value, a data burst volume value, a reflective QoS attribute value, periodicity value, or a combination thereof; and each service class of the plurality of service classes is associated with a delay bound value, a packet loss ratio value, a priority value, a minimum throughput value, a maximum throughput value, a burst size value, a priority value, a service interval value, or a combination thereof.

Aspect 18: The method of any of aspects 1 through 17, further comprising: mapping each QoS flow of the plurality of QoS flows to one or more service classes of the plurality of service classes based at least in part on a QoS identifier of the plurality of QoS flows and a mapping table including the plurality of service classes, description information associated with each QoS flow, and packet filter information.

Aspect 19: The method of any of aspects 1 through 18, wherein transmitting the mapping information comprises: transmitting an indication of one or more QoS identifiers that are mapped to a service class of the plurality of service classes, description information associated with each QoS flow, a packet filter set per QoS flow, or any combination thereof.

Aspect 20: The method of aspect 19 wherein transmitting the mapping information comprises: transmitting description information that indicates a maximum flow bit rate per QoS flow, a guaranteed flow bit rate per QoS flow, an averaging window per QoS flow, the QoS identifier per QoS flow, or a combination thereof.

Aspect 21: The method of any of aspects 1 through 20, wherein the first RAT is cellular communication technology and the second RAT is Wi-Fi.

Aspect 22: A method for wireless communication at first network device, comprising: receiving, from a second network device, mapping information indicating a mapping of each QoS flow of a plurality of QoS flows of a first RAT to one or more service classes of a plurality of service classes of a second RAT supported by the first network device; translating, using a translation rule included in the mapping information, a header of a packet between a first network address of the first RAT and a second network address used by the first network device; and communicating the packet between a device associated with the first network device using a first service class of the plurality of service classes and a first QoS flow of the plurality of QoS flows based at least in part on translation of the header.

Aspect 23: The method of aspect 22, wherein the mapping information comprises an indication of a set of internet protocol addresses that are to be communicated to a QoS flow; and the header is translated based at least in part on the set of internet protocol addresses.

Aspect 24: The method of any of aspects 22 through 23, further comprising: transmitting, to the second network device, an indication of the plurality of service classes; and wherein the mapping information is received based at least in part on transmitting the indication of the plurality of service classes.

Aspect 25: The method of any of aspects 22 through 24, further comprising: transmitting, to the second network device, a second packet that includes a traffic identifier that is mapped to a default QoS flow associated with the first RAT; and wherein the mapping information is received based at least in part on transmitting the second packet.

Aspect 26: The method of aspect 25, further comprising: receiving from the device the second packet via a default service class; and wherein the second packet is transmitted to the second network device based at least in part on receiving the second packet from the device.

Aspect 27: The method of any of aspects 22 through 26, wherein communicating the packet comprises: receiving via the first service class, the packet from the device; inserting, into a header of the packet, a traffic identifier that corresponds to the first service class based at least in part on the mapping information; and transmitting, to the second network device, the packet that includes the traffic identifier.

Aspect 28: The method of aspect 27, wherein the traffic identifier is a virtual local area network tag.

Aspect 29: The method of any of aspects 22 through 28, wherein translating the header of the packet comprises: receiving the packet from the second network device, the packet including the first network address; replacing the first network address with the second network address that is mapped to the first network address via the mapping information; and wherein the packet is transmitted to the device via the first service class.

Aspect 30: The method of any of aspects 22 through 29, wherein translating the header of the packet comprises: receiving, the packet from the device, the packet including the second network address; replacing the second network address with the first network address that is mapped to the second network address via the mapping information; and wherein the packet is transmitted to the second network device.

Aspect 31: The method of any of aspects 22 through 30, further comprising: scheduling communication of a plurality of packets including the packet based at least in part on a respective service class associated with each of the plurality of packets; and wherein the packet is communicated based at least in part on the scheduling.

Aspect 32: The method of any of aspects 22 through 31, wherein the mapping information is received via a DHCP, or a serial communication, or a HTTP.

Aspect 33: The method of any of aspects 22 through 32, wherein the mapping information is received by a DHCP client at the first network device and via a DHCP offer message that is transmitted by a DHCP server at the second network device; and the DHCP offer message includes the mapping information and indicates an identifier configured to cause the DHCP client to refrain from discarding the DHCP offer message.

Aspect 34: The method of any of aspects 22 through 33, wherein receiving the mapping information comprises an indication of one or more QoS identifiers that are mapped to a service class of the plurality of service classes, description information associated with each QoS flow, a packet filter set per QoS flow, or any combination thereof.

Aspect 35: The method of aspect 34, wherein receiving the mapping information comprises receiving description information that indicates a maximum flow bit rate per QoS flow, a guaranteed flow bit rate per QoS flow, an averaging window per QoS flow, the QoS identifier per QoS flow, or a combination thereof.

Aspect 36: The method of any of aspects 22 through 35, wherein the mapping information does not include information associated with an ethernet port of the first network device.

Aspect 37: The method of any of aspects 22 through 36, wherein the first network device and the second network device are included in a CPE.

Aspect 38: The method of any of aspects 22 through 37, wherein the first RAT is cellular communications technology and the second RAT is Wi-Fi.

Aspect 39: An apparatus for wireless communication at a first network device, comprising a processor; memory coupled with the processor; and instructions stored in the memory and executable by the processor to cause the apparatus to perform a method of any of aspects 1 through 21.

Aspect 40: An apparatus for wireless communication at a first network device, comprising at least one means for performing a method of any of aspects 1 through 21.

Aspect 41: A non-transitory computer-readable medium storing code for wireless communication at a first network device, the code comprising instructions executable by a processor to perform a method of any of aspects 1 through 21.

Aspect 42: An apparatus for wireless communication at first network device, comprising a processor; memory coupled with the processor; and instructions stored in the memory and executable by the processor to cause the apparatus to perform a method of any of aspects 22 through 38.

Aspect 43: An apparatus for wireless communication at first network device, comprising at least one means for performing a method of any of aspects 22 through 38.

Aspect 44: A non-transitory computer-readable medium storing code for wireless communication at first network device, the code comprising instructions executable by a processor to perform a method of any of aspects 22 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first network device, comprising:
a processor;
memory coupled with the processor; and
instructions stored in the memory and executable by the processor to cause the apparatus to:
transmit, to a second network device, mapping information indicating a mapping of each quality of service flow of a plurality of quality of service flows of a first radio access technology to one or more service classes of a plurality of service classes of a second radio access technology, wherein the mapping is based at least in part on a set of quality of service parameter values for the plurality of quality of service flows; and
communicating, based at least in part on the mapping information, a packet between a first quality of service flow of the plurality of quality of service flows and a first service class of the plurality of service classes.

2. The apparatus of claim 1, wherein the instructions are further executable by the processor to cause the apparatus to:
receive, from the second network device, an indication of the plurality of service classes of the second radio access technology,
wherein each quality of service flow is mapped to the one or more service classes based at least in part on receiving the indication of the plurality of service classes.

3. The apparatus of claim 1, wherein the instructions are further executable by the processor to cause the apparatus to:
receive, via the first radio access technology, control signaling indicating the set of quality of service parameter values per quality of service flow of the plurality of quality of service flows.

4. The apparatus of claim 3, wherein:
the control signaling comprises a set of internet protocol addresses that are to be communicated via a quality of service flow of the plurality of quality of service flows; and
the quality of service flow is mapped to at least one of the plurality of service classes based at least in part on the set of internet protocol addresses.

5. The apparatus of claim 4, wherein the set of internet protocol addresses are received from a policy control function associated with the first radio access technology.

6. The apparatus of claim 4, wherein the mapping information comprises an indication of the set of internet protocol addresses that are to be communicated via the quality of service flow.

7. The apparatus of claim 1, wherein the instructions are further executable by the processor to cause the apparatus to:
receive, from the second network device, an indication of the plurality of service classes of the second radio access technology;
transmit, based at least in part on the indication of the plurality of service classes and using a default quality of service flow, uplink control signaling requesting the plurality of quality of service flows; and
receive, via the first radio access technology based at least in part on the uplink control signaling, control signaling indicating a set of quality of service parameter values per quality of service flow of a plurality of quality of service flows of a first radio access technology.

8. The apparatus of claim 1, wherein the instructions to communicate the packet are executable by the processor to cause the apparatus to:
receive, from the second network device, the packet comprising a traffic identifier; and
transmit the packet via the first quality of service flow based at least in part on the traffic identifier that is mapped to the first quality of service flow.

9. The apparatus of claim 8, wherein the instructions are further executable by the processor to cause the apparatus to:
remove the traffic identifier from the packet before transmitting the packet via the first quality of service flow based at least in part on the traffic identifier corresponding to an internet protocol based quality of service flow.

10. The apparatus of claim 8, wherein the packet comprising the traffic identifier is transmitted via the first quality of service flow based at least in part on the first quality of service flow being an Ethernet based quality of service flow.

11. The apparatus of claim 1, wherein the mapping information is transmitted via a dynamic host configuration protocol message, a serial communication, or a hypertext transfer protocol message.

12. The apparatus of claim 1, wherein:
the mapping information is transmitted by a dynamic host configuration protocol (DHCP) server at the first network device and via a DHCP offer message that is transmitted to a DHCP client at the second network device; and
the DHCP offer message includes the mapping information and indicates an identifier configured to cause the DHCP client to refrain from discarding the DHCP offer message.

13. The apparatus of claim 1, wherein the instructions are further executable by the processor to cause the apparatus to:
refrain from mapping an ethernet port of the second network device to a quality of service flow.

14. The apparatus of claim 1, wherein:
the set of quality of service parameter values per quality of service flow comprise a delay budget value, a packet error rate value, a priority value, a bit rate value, a data burst volume value, a reflective quality of service attribute value, periodicity value, or a combination thereof; and
each service class of the plurality of service classes is associated with a delay bound value, a packet loss ratio value, a priority value, a minimum throughput value, a maximum throughput value, a burst size value, a priority value, a service interval value, or a combination thereof.

15. The apparatus of claim 1, wherein the instructions are further executable by the processor to cause the apparatus to:
map each quality of service flow of the plurality of quality of service flows to one or more service classes of the plurality of service classes based at least in part on a quality of service identifier of the plurality of quality of service flows and a mapping table including the plurality of service classes, description information associated with each quality of service flow, and packet filter information.

16. The apparatus of claim 1, wherein the instructions to transmit the mapping information are executable by the processor to cause the apparatus to:
transmit an indication of one or more quality of service identifiers that are mapped to a service class of the plurality of service classes, description information associated with each quality of service flow, a packet filter set per quality of service flow, or any combination thereof.

17. The apparatus of claim 1, wherein the instructions to transmit the mapping information are executable by the processor to cause the apparatus to:
transmit description information that indicates a maximum flow bit rate per quality of service flow, a guaranteed flow bit rate per quality of service flow, an averaging window per quality of service flow, the quality of service identifier per quality of service flow, or a combination thereof.

18. An apparatus for wireless communication at first network device, comprising:
a processor;
memory coupled with the processor; and
instructions stored in the memory and executable by the processor to cause the apparatus to:
receive, from a second network device, mapping information indicating a mapping of each quality of service flow of a plurality of quality of service flows of a first radio access technology to one or more service classes of a plurality of service classes of a second radio access technology supported by the first network device;
translate, using a translation rule included in the mapping information, a header of a packet between a first network address of the first radio access technology and a second network address used by the first network device; and
communicate the packet between a device associated with the first network device using a first service class of the plurality of service classes and a first quality of service flow of the plurality of quality of service flows based at least in part on translation of the header.

19. The apparatus of claim 18, wherein:
the mapping information comprises an indication of a set of internet protocol addresses that are to be communicated to a quality of service flow; and
the header is translated based at least in part on the set of internet protocol addresses.

20. The apparatus of claim 18, wherein the instructions are further executable by the processor to cause the apparatus to:
transmit, to the second network device, an indication of the plurality of service classes,
wherein the mapping information be received based at least in part on transmitting the indication of the plurality of service classes.

21. The apparatus of claim 18, wherein the instructions are further executable by the processor to cause the apparatus to:
transmit, to the second network device, a second packet that includes a traffic identifier that is mapped to a default quality of service flow associated with the first radio access technology,
wherein the mapping information be received based at least in part on transmitting the second packet.

22. The apparatus of claim 21, wherein the instructions are further executable by the processor to cause the apparatus to:
receive from the device the second packet via a default service class,
wherein the second packet be transmitted to the second network device based at least in part on receiving the second packet from the device.

23. The apparatus of claim 18, wherein the instructions to communicate the packet are executable by the processor to cause the apparatus to:
receive via the first service class, the packet from the device;
insert, into a header of the packet, a traffic identifier that corresponds to the first service class based at least in part on the mapping information; and
transmit, to the second network device, the packet that includes the traffic identifier.

24. The apparatus of claim 18, wherein the instructions to translate the header of the packet are executable by the processor to cause the apparatus to:
receive the packet from the second network device, the packet including the first network address; and
replace the first network address with the second network address that is mapped to the first network address via the mapping information,
wherein the packet is transmitted to the device via the first service class.

25. The apparatus of claim 18, wherein the instructions to translate the header of the packet are executable by the processor to cause the apparatus to:
receive, the packet from the device, the packet including the second network address; and
replace the second network address with the first network address that is mapped to the second network address via the mapping information,
wherein the packet is transmitted to the second network device.

26. The apparatus of claim 18, wherein the instructions are further executable by the processor to cause the apparatus to:
scheduling communication of a plurality of packets include the packet based at least in part on a respective service class associated with each of the plurality of packets,
wherein the packet is communicated based at least in part on the scheduling.

27. The apparatus of claim 18, wherein the mapping information is received via a dynamic host configuration protocol message, a serial communication, or a hypertext transfer protocol message.

28. The apparatus of claim 18, wherein:
the mapping information is received by a dynamic host configuration protocol (DHCP) client at the first network device and via a DHCP offer message that is transmitted by a DHCP server at the second network device; and
the DHCP offer message includes the mapping information and indicates an identifier configured to cause the DHCP client to refrain from discarding the DHCP offer message.

29. A method for wireless communication at a first network device, comprising:
transmitting, to a second network device, mapping information indicating a mapping of each quality of service flow of a plurality of quality of service flows of a first radio access technology to one or more service classes of a plurality of service classes of a second radio access technology, wherein the mapping is based at least in part on a set of quality of service parameter values for the plurality of quality of service flows; and
communicating, based at least in part on the mapping information, a packet between a first quality of service flow of the plurality of quality of service flows and a first service class of the plurality of service classes.

30. A method for wireless communication at first network device, comprising:
receiving, from a second network device, mapping information indicating a mapping of each quality of service flow of a plurality of quality of service flows of a first radio access technology to one or more service classes of a plurality of service classes of a second radio access technology supported by the first network device;
translating, using a translation rule included in the mapping information, a header of a packet between a first network address of the first radio access technology and a second network address used by the first network device; and
communicating the packet between a device associated with the first network device using a first service class of the plurality of service classes and a first quality of service flow of the plurality of quality of service flows based at least in part on translation of the header.
